(19) United States
(12) Patent Application Publication
(10) Pub. No.: US 2005/0081175 A1
(43) Pub. Date: Apr. 14, 2005

(54) Method for discrete gate sizing in a netlist

(76) Inventors: William Franson Scott, Sunnyvale, CA (US); Viktor Lapinskii, San Jose, CA (US)

Correspondence Address: Anthony T. Cascio;Suite 314, 423 Broadway Ave., Millbrae, CA, 94030-1905, US

(21) Appl. No.: 10/683,628

(22) Filed: Oct. 10, 2003

(51) Int. Cl. G06F 17/50; G06F 9/45

(52) U.S. Cl. 716/12; 716/7; 716/6; 716/18

(57) ABSTRACT

A set of gate sizes for a netlist having a plurality of gates wherein for each of the gates a number of discrete gate sizes is available is selected such that the selection minimizes worst slack in the netlist. A current gate size for each gate is selected and an a current weight assigned to each one of the timing edges in the netlist. A new gate size is selected for each one of the gates from one of the current gate size and second one of the available gates sizes wherein such selection of each new gate size minimizes a sum of weighted delays obtained over all timing edges. The minimum sum of weighted delays is obtained from a min-cut in a timing flow graph. The results of the min-cut are used in the next iteration and re-iterating occurs until an exit criteria is determined.

### BACKGROUND OF THE INVENTION

The present invention relates generally to gate sizing in integrated circuit design and more particularly to a novel apparatus and method for network-based gate sizing in standard cell design.

In a MOS integrated circuit, one parameter relating to the ability of a driver transistor to charge or discharge a load, C_{L}, is the channel width of the driver transistor which determines its output resistance, R, and hence the RC time constant upon which the switching speed depends. For a constant load, C_{L}, an increase in the channel width of the driver transistor decreases its output resistance, R, thereby increasing switching speed. Conversely, for the same load, C_{L}, a decrease the channel width of the driver transistor increases its output resistance, R, thereby decreasing switching speed.

When performing a timing analysis of the integrated circuit, a faster switching speed at this driver transistor may be required to maintain timing constraints within the MOS circuit. One solution would be to simply to increase the channel width of this transistor, for the reasons above stated. However, this transistor may also be a load of a previous transistor in the circuit. Since increasing the channel width of a MOS transistor increases its input gate capacitance, the load seen by the previous transistor increases, thereby resulting in slower switching at the previous stage. Accordingly, timing constraints may not then be met at the previous stage.

In the design of the data paths in a reasonably sized MOS integrated circuit, the smallest component design is generally a logic stage or standard cell, hereinafter referred to as a gate. Each gate is composed of various circuit components to implement its predefined function. The load, C_{L}, referred to above thus is typically the sum of each input gate capacitance, Cᵢₙ, seen at an input pin of the gate, when being a receiver gate switched by the driver transistor in the example above. Such gate, of course, also has an output pin at which the function and size of the driver transistor in the above example is found.

Typically, each gate used in the design has previously been implemented in library, such that the components within the gate are not subject to further design variations outside of the library implementation Accordingly, selection of a gate from a library for a required size of its output transistor determines its corresponding input gate capacitance, and vice versa. Typically to provide design flexibility, for each gate in one logical family several variations of the gate are available from the library. Each of these variations for one particular gate is referred to as the gate size. Accordingly, timing along data paths and maintaining the requisite timing constraints becomes a problem of selecting gate sizes for each gate in the circuit.

For example, in FIG. 1 (Prior Art) there is shown a simple MOS circuit 10, which may be a portion of a much larger circuit. The circuit 10 includes a plurality of gates 12₁₋₇, for which there are known library implementations and for each one of the gates 12₁₋₇ several sizes are available. For purposes of this exemplary circuit 10, it shall be assumed that for each available size for each one of the gates 12₁₋₇ channel width dependencies between transistors within each one of the gates 12₁₋₇ require that all such channel widths remain proportionally dependent within each one of the gates 12₁₋₇ as it is upsized or downsized. Accordingly, a larger or smaller gate size for any one of the gates 12₁₋₇ respectively results in a larger or smaller input capacitance and in a smaller or larger output resistance.

Should the results of a timing analysis indicate that timing constraints are not met between a driver gate, such as gate 12₁ and its receiver gates, such as gate 12₂ and gate 12₃, faster switching between the driver gate and each receiver gate would need to occur. Accordingly, either the size of gate 12₁, as the driver gate, would need to be made larger, or the size of each of gate 12₂ and gate 12₃, as the receiver gates, would need to be smaller. For reasons as stated above, increasing the size of gate 12₁ decreases its output resistance allowing faster switching and decreasing the size of gate 12₂ and gate 12₃ decreases the size of their respective input capacitance, also allowing faster switching. It may also be required that gate 12₁ is made larger simultaneously with gate 12₂ and gate 12₃ being made smaller.

If the size of gate 12₁ is made larger, then its input capacitance, Cᵢₙ, is also made larger to due the increased channel widths in this gate. Accordingly, when gate 12₁ is a receiver gate for either the one of a previous driver gate, such as gate 12₄ or gate 12₅, either one of these previous stages if kept the same size may be unable to switch gate 12₁ quickly enough to maintain timing constraints in the circuit 10.

Similarly, if the size of each receiver gate 12₂ and receiver gate 12₃ are made smaller, then each of their corresponding output resistance is made smaller due to the decreased channel widths in each of these gates. Accordingly, when either of gate 12₂ or gate 12₃ is a driver gate for a subsequent receiver gate, such as gate 12₆ and gate 12₇, neither of gate 12₂ or gate 12₃ may be unable to switch the subsequent stage if kept the same size quickly enough to maintain the timing constraints in the circuit 10.

In addition to the switching speed between the driver gate and each receiver gate, there also exists a timing delay through the driver gate. Since switching speed is an inverse of delay, a total delay, τ, between the input of a driver gate to the input of each receiver gate may be expressed as
τ=K+RΣCᵢₙ (1)
wherein K is a delay constant through the driver gate, R is the output resistance of the driver gate and Cᵢₙ is the input capacitance of the receiver gate. It is apparent from the above discussion that the delay constant K and the output resistance R are dependent upon the driver gate size, x_{drv} and each input capacitance Cᵢₙ is dependent upon the receiver gate size xᵣ.

It is readily seen from Eq. (1) that when selecting the size for each one of the gates 12₁₋₇ in the circuit 10 to meet timing constraints, several parameters need be considered. In a simple circuit, such as the exemplary circuit 10, the selection of gate size for each of the gates 12₁₋₇ may be accomplished without much difficulty. However, even an optimization of timing obtained for each possible combination of sizes for the gates 12₁₋₇ could be unduly burdensome should many such sizes exist for each of the gates 12₁₋₇. Because of the interdependencies each of these parameters have in regards to timing within each gate and between gates, it may be appreciated by those skilled in the art that as the number of gates in an integrated circuit increases, the complexity of selecting gate sizes for each of the gates 12₁₋₇ accordingly increases.

In the prior art, the design of a complex integrated circuit is generally defined by a netlist, which is a set of data used by design automation tools. The problem of determining the optimal size of each instance of a gate in the netlist has been addressed by analyzing the slack on all of the endpoints in a circuit. As is known, slack is the difference between the required time and arrival time at the endpoint. If the arrival time is later than the required time, the difference is negative. Accordingly, negative slack on an endpoint indicates that the timing requirement is not met at that endpoint. Conversely, negative slack indicates that the actual delay on the path exceeds the required delay.

It then follows that the worst slack, WS, of a circuit with a set, P, of paths, p, may be expressed as a difference of path delay, PathDelay(p), and required delay RequiredDelay(p), or:

$$WS = - {max}_{p ∈ P} ( PathDelay ( p ) - RequiredDelay ( p ) ) . \qquad ( 2 )$$

The path delay, PathDelay(p), on any path, p, is in turn defined as the sum of each timing edge delay, delay(e), on all of the timing edges, e, in such path, or

$$PathDelay ( p ) = {\sum }_{e ∈ P}^{} delay ( e ) \qquad ( 3 )$$

wherein a timing edge, e, transitions at an input of a driver gate and extends to the input of a receiver gate, as best seen in FIG. 1. Since the delay, delay(e), on each edge, e, is then know to be dependent upon the size of the driver gate and each receiver gate, as described above with reference to Eq. (1), the size of each of the gate instances in the netlist can thus be selected to optimize slack. Accordingly, the gate sizing for slack optimization can be expressed as finding a vector of gate sizes \vec{x} in a solution space, X, that minimizes a negative value of the worst slack (Eq. 2), or —WS, or

$${min}_{\vec{x} ∈ X} [ {max}_{p ∈ P} ( PathDelay ( p ) - RequiredDelay ( p ) ) ] . \qquad ( 4 )$$

In a typical netlist, a solution to the min/max problem of Eq. 4 is extremely difficult to obtain due to the large number of paths and number of gate instances in the netlist compounded by all of the possible combinations of gate sizes for each of the gate instances. For a typical netlist, a solution to Eq. (4) may not be readily obtainable in a reasonable time.

The problem may be refined by considering paths in the netlist that have worse slack than other paths, since these paths are more critical to optimize than the others, and assigning weights to timing edges in these paths. The timing edge in each of these paths for which its slack is the worst slack in its path may be assigned the largest weight in the path. Similarly, the timing edge having the worst slack in the path having the worst slack of all paths may generally be assigned the largest of all weights.

For example, in FIG. 1 a first path may terminate at an endpoint 14 and a second path may terminate at an endpoint 16. The slack, slk, at the endpoint 14 on the first path is exemplarily indicated as positive, or slk>0, showing that timing constraints are met such that the path delay is less than the required delay. However, the slack, slk, at the endpoint 16 is exemplarily indicated as negative, or slk<0, showing otherwise. A timing edge 18 transitioning at the input of gate 12₃ and terminating at the input of gate 12₇ may exemplarily be identified as contributing the worst slack on the second path Accordingly, the timing edge 18 will receive the largest weight. The weights allow the timing edges with the largest weights to be optimized in favor over the edges with relatively lesser weights. However, it can be readily appreciated by those skilled in the art that obtaining a direct solution to the min/max problem of Eq. 4 for various combinations of gate sizes along each timing edge in the typical netlist, even when first considering the most critical edges first, remains computationally intensive.

As taught in Chen, et al., Fast and Exact Simultaneous Gate and Wire Sizing By Lagrangian Relaxation, Proceedings of the 1998 IEEE/ACM International Conference on Computer Aided Design (ICCAD-98), pp 617-624, ACM/IEEE, November 1998, the min/max problem of Eq. 4 may be solved in a continuous domain after being converted to the following form using Lagrangian relaxation:

$${max}_{\vec{w}} [ {min}_{\vec{x} ∈ X} ( {\sum }_{e ∈ E }^{} w ( e ) delay ( e ) ) ] \qquad ( 5 )$$

wherein E is a set of edges, e, in the timing graph, and w(e) is a weight associated the timing edge, e. As described in Chen, et al., the set of weights, \vec{w}, on the edges, e, at in the timing graph must satisfy a unit flow condition, i.e., at any node in the timing graph the sum of weights on all incoming edges must equal the sum of weights on all outgoing edges. Accordingly, it can be seen from the teachings of Chen, et al., in Eq. (5) that the problem of finding a set of gate sizes, \vec{x}, that minimizes worst slack, as set forth in Eq. (4) becomes a problem of finding a set of gate sizes, \vec{x}, that minimizes a sum of the weighted delays expressed in Eq. (5) as follows:

$${min}_{\vec{x} ∈ X} ( {\sum }_{e ∈ E }^{} w ( e ) delay ( e ) ) . \qquad ( 6 )$$

The use of the minimum sum of weighted delays to optimize gate size can qualitatively be set forth with reference to FIG. 1. For example, a first timing edge 22 transitioning at an input 20 of gate 12₁ and extending to the input of gate 12₂ has a weight w(e₂₂) and a second timing edge 24 also transitioning at the input of gate 12₁ but extending to the input of gate 12₃ has a weight w(e₂₄). Since the second timing edge 24 is in the path terminating at endpoint 16 and further since this path has a higher criticality as set forth above, the weight w(e₂₄) on timing edge 24 is therefore larger than the weight w(e₂₂) on timing edge 24. To minimize the sum of weighted delays as set forth in Eq. (6), the delay on timing edge 24, delay(e₂₄), would need to be minimize to minimize the weighted delay product in Eq. 6 for this edge 24.

From the above discussion, the delay, delay(e₂₄), on timing edge 24 is known to be a function of the size of gate 12₁ and a total input capacitance, COₜₒₜ, which is the sum of each input capacitance, Cᵢₙ, of gate 12₂ and gate 12₃ and a wire capacitance of the net between gate 12₂ and gate 12₃. Accordingly, the delay as expressed in Eq. (1) can be rewritten for any timing edge, e, as a function of the driver gate size, X_{drv}, and total receiver capacitance, COₜₒₜ, as
delay(e)=ƒ(x_{drv}, Cₜₒₜ) (7)
It can therefore be seen, that the minimization of the sum of weighted delays, as set forth in Eq. (6), is dependent on gate size such that gate sizes can be obtained which minimizes delay on the heaviest of the weighted edges.

Although the weighted delay gate sizing, as set forth in Eq. (5) is easier to solve than the min/max problem set forth in Eq. (4), the solution to Eq. 4 is in the continuous domain, i.e., the solution is a continuum of gate sizes for each gate and does not result in a set of gate sizes that are obtainable from a library. Accordingly, Eq. (5) cannot be used directly for the standard cell methodology, in which for each gate instance in the netlist, one or more discrete gate sizes are available for selection, as discussed above. However, standard cell methodology is the primary methodology used for the design of complex integrated circuits, especially application specific integrated circuits (ASIC's) and it is, therefore, highly desirous to obtain a gate sizing solution in this methodology that minimizes as sum of weighted delays for gate size optimization.

In order to solve the more practical discrete gate sizing problem, it is known in the art to first obtain a solution to Eq. (5) in the continuous domain and then use such solution as a starting point to obtain a solution in the discrete domain. Typically, the entry into the discrete domain is to round off the results of the continuous domain, which may disadvantageously lead to a result, instead of minimizing delay on a critical path, could actually result in increased delay on such path.

For example, in FIG. 2 (Prior Art), there is shown a portion of the circuit 10 of FIG. 1, including gates 12₁₋₃, as described above. Each gate 12₁₋₃ is a member of a logic family, LogicFamily, and in each logic family, several gate sizes, x_{gate}, are available from the library, such that
x_{gate} ε LogicFamily. (8)
The logic family for gate 12₁ is exemplarily shown as having three discrete sizes,

$${x}_{{12}_{1}} = \{ \begin{matrix}x = 1 \\ x = 2 \\ x = 3\end{matrix} \} , \qquad ( 9 )$$

shown as gate 12₁^{x=1} gate 12₃^{x=2} and gate 12₁^{x=3}, and the logic family for gate 12₃ is exemplarily shown as having two discrete sizes,

$${x}_{{12}_{3}} = \{ \begin{matrix}x = 1 \\ x = 2\end{matrix} \} , \qquad ( 10 )$$

shown as gate 12₃^{x=1} and gate 12₃^{x=2}. It is to be understood that each gate instance may have any number of discrete sizes. A solution may then be obtained for Eq. (5) in the continuous domain, and data obtained relating specifically to the continuous sizes of gate 12₁ and gate 12₃ on timing edge 24.

With further reference to FIG. 3 (Prior Art), there is shown a graph for the continuous domain solution with continuous sizes x₁₂_{₃} for gate 12₃ on the ordinate and continuous sizes x₁₂_{₁} for gate 12₁ on the abscissa. The data obtained for an exemplary solution to Eq. 5 for timing edge 24 may result in a series of contours 26 about a locus 28. The locus 28 represents an optimal solution for gates sizes x₁₂_{₁} and x₁₂_{₃} in the continuous domain, and the contours 26 represent increasingly less desirable solutions for each increasing size of the contours 26 outward from the locus 28.

Superimposed on the graph of FIG. 3, for gate 12₁ and gate 12₃ are their discrete gate sizes x₁₂_{₁} and x₁₂_{₃}, as respectively set forth in Eq. (9) and Eq. (10). As set forth above a continuous domain solution is used to enter the discrete domain by rounding off the optimal gate sizes, as indicated at the locus 28, to the nearest discrete gate sizes. As visually indicated in FIG. 3, the nearest round-off point for the discrete sizes x₁₂_{₁} and x₁₂_{₃} from the locus 28 is at a data point 30 at which gate 12₁ has a discrete size x₁₂_{₁}=1 and gate 12₃ has a discrete size x₁₂_{₃}=2.

It can readily be seen in the graph of FIG. 3 that to reach the nearest round-off point at data point 30, five of the contours 26 are crossed and that the contours are closely spaced. Accordingly, the slope of the continuous domain solution to Eq. (5) is relatively steep between the locus 28 and data point 30 and, as stated above, each contour 26 farther away from the locus 28 indicates an increasingly less desirable continuous domain solution.

A more preferable solution for this example would be at a data point 32 at which gate 12₁ has a discrete size x₁₂_{₁}=2 and gate 12₃ has a discrete size x₁₂_{₃}=2. As seen in the graph of FIG. 3, the slope between the locus 28 and data point 32 is far lesser in that only two contours 26 are crossed. However, since the discrete size discrete size x₁₂_{₁}=2 for gate 12₁ is farther from the locus 28 than for its smaller size, the rounding used in the prior art would not select the more preferable size.

The discrete size x₁₂_{₁}=2 for gate 12₁ as more preferable is also apparent from the above example described in reference to FIG. 1. Since timing edge 24 is on the path terminating at endpoint 16 (FIG. 1), and this path was indicated having a higher criticality, delay on timing edge 24 would be reduced if the larger size for gate 12₁ were used instead of the smaller size suggested by rounding of the continuous domain solution.

### SUMMARY OF THE INVENTION

According to the present invention, a method to select a set of gate sizes for a netlist having a plurality of gates wherein for each of the gates a number of discrete gate sizes is available for selection such that the selection minimizes worst slack in the netlist includes the steps of selecting a current first gate size for each one of the gates, performing a static timing analysis to determine slack, assigning a current weight to each one of the timing edges in the netlist based on the results of the timing analysis, selecting a new gate size for each one of the gates from one of the current gate size and a second gate size from the available gates sizes wherein such selection of each new gate size minimizes a sum of weighted delays obtained over all timing edges, and re-iterating each of the forgoing steps until an exit criteria is determined.

At an initial iteration of the current gate size selecting step the current gate size is selected to be an initially selected on of the available gate sizes, an at each subsequent iteration of the selecting step the current gate size for each of the gates is the new gate size for each corresponding one of the gates from an immediately prior iteration. In each iteration, the current weight assigned to each edge may be determined from a current worst slack determined from the timing analysis using the current gate size. In one particular embodiment of the present invention, the second gate size alternates between a next larger size and a next smaller size in successive iterations. The set of gate sizes selected from the forgoing method is the set from the iteration for which the current worst slack is determined to be minimal.

In one aspect of the present invention, a method to obtain the minimum sum of weighted delays in the netlist for a set of gates wherein for each gate only the first gate size and the second gate size are considered includes defining for the netlist an equivalent flow graph, computing a value of a first attribute for each node in the flow graph wherein each node corresponds to one of the gates in the netlist, and computing a value of a second attribute for each arc between a pair of nodes in the flow graph wherein each arc corresponds to the timing edges between each pair of gates to which the pair of nodes corresponds. The second attribute is assigned as a flow capacity for the arc for which it was computed. The method continues with placing a source arc between a source node and each node for which its first attribute is positive and placing a sink arc between a sink node and each node for which its first capacity attribute is negative. For each source arc its flow capacity is assigned the computed value of the first attribute of the node to which it is placed, and for each sink arc its flow capacity is assigned the negative of the computed value of the first attribute of the node to which it is placed. The method further continues with partitioning the flow graph into a source partition and a sink partition such that a sum of the value of the flow capacity on all arcs cut by the partitioning is a minimum sum for all possible partitions. the method concludes with selecting for the set of gates sizes the first gate size for each of the gates for which its corresponding node is in the source partition and the second gate size for each of the gates for which its corresponding node is in the sink partition.

In the above method, the value of the first attribute for each node is determined from an assigned weight and a plurality of delay coefficients, described below, associated with each of the timing edges incoming to and outgoing from one of the gates to which each node respectively corresponds. Similarly, the value of the second attribute for each arc between a pair of nodes is determined from the assigned weight and selected ones of the delay coefficients for each one of the timing edges between a pair of gates to which a pair of nodes corresponds.

The delay coefficients associated with each of the timing edges are determinable from a plurality of calculated delays between a driver gate and a set of receiver gates for each combination of the driver gate being one of the first gate size and the second gate size and the set of receiver gates all being one of the first gate size and the second gate size.

As described above, the min/max path delay expression of Eq. (4) is limited in its application to typically sized netlists due to the number of gates and the number of discrete sizes for each of the gates available from libraries. When considering every possible combination of gate sizes, the time required to reach a solution may disadvantageously be so excessive such that a solution may not be possible in a reasonable time.

Also as described above, the continuous minimum sum of weighted delays expression of Eq. (5), although solvable in a reasonable time, is limited in its application to discrete sizes available from a library. When rounding a continuous solution for a driver and receiver gate on a timing edge, the rounding may disadvantageously select a less preferential size of driver and receiver which may further increase delay on a critical path.

The present invention overcomes the above described disadvantages and limitations of the prior art by providing a novel discrete gate sizing method in which the minimum sum of weighted delays expression is used to solve a discrete domain problem through a reiterative process that considers only two sizes for each gate instance in each iteration. A feature of the present invention is that the reiterative process has an inner loop process and an outer loop process. The inner loop process is performed for each iteration of the outer loop process.

In the inner loop, the continuous minimum sum of weighted delays when considering only two possible gates sizes for each gate becomes solvable as a well known min-cut/max flow solution that is readily obtained in real time and directly applicable to the discrete domain. A feature of the inner loop is that for each gate after a solution is obtained, each gate in the netlist will be one of either of the two sizes.

In the outer loop, a starting set of gate sizes and weights for each timing edge are assigned. One feature of the outer loop is that the starting set of gate sizes relates to the solution set of gate sizes of the inner loop of a prior iteration. Another feature of the outer loop in another embodiment of the present invention is that the weight assigned on each edge in each iteration is refined based on the weight of the prior iteration such that the reiterative process converges quicker to a preferred solution.

The present invention is able to optimize delays on critical paths by using the minimum sum of weighted delay expression, but advantageously apply it to the discrete domain by transforming the netlist into an equivalent flow graph for which optimization is readily obtained using well known min-cut/max flow algorithms. One particular advantage is that the partitioning of the flow graph to find the optimum gate size is readily achievable in a reasonable time proportional to N³ or N²E time wherein N and E are number of gates and number of edges, respectively.

These and other objects, advantages and features of the present invention will become readily apparent to those skilled in the art form a study of the following Description of the Exemplary Preferred Embodiments when read in conjunction with the attached Drawing and appended Claims.

### BRIEF DESCRIPTION OF THE DRAWING

FIG. 1 (Prior Art) is a block diagram of an exemplary circuit useful to describe prior art gate sizing methods;

FIG. 2 (Prior Art) is a portion of the circuit of FIG. I showing available discrete gate sizes for each gate;

FIG. 3 (Prior Art) is a graph showing an exemplary solution to a continuous domain minimum weighted sum of delays as applied to two gates of FIG. 2;

FIG. 4 is a flowchart of a novel method in which a minimum sum of weighted delays solution is transformed into a solution of a min-cut/max flow problem;

FIG. 5 is an exemplary flow graph defined in the flow graph defining step of FIG. 4;

FIG. 6 is a flowchart of the method to calculate the attributes of the attribute computing steps of FIG. 4;

FIG. 7 is a flowchart of the arc placing step of FIG. 4;

FIG. 8 is a flowchart of the gate size selecting step of FIG. 4;

FIG. 9 is a flowchart setting forth the a novel gate sizing method according to the principles of the present invention;

FIG. 10 is a flowchart of the current gate size selecting step of FIG. 9; and

FIG. 11 is a flowchart of the current weight assigning step of FIG. 9.

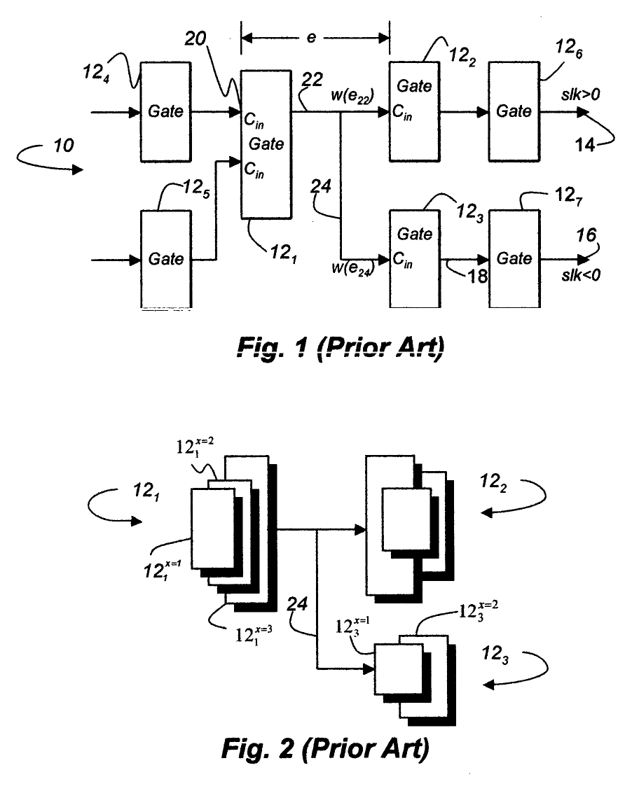

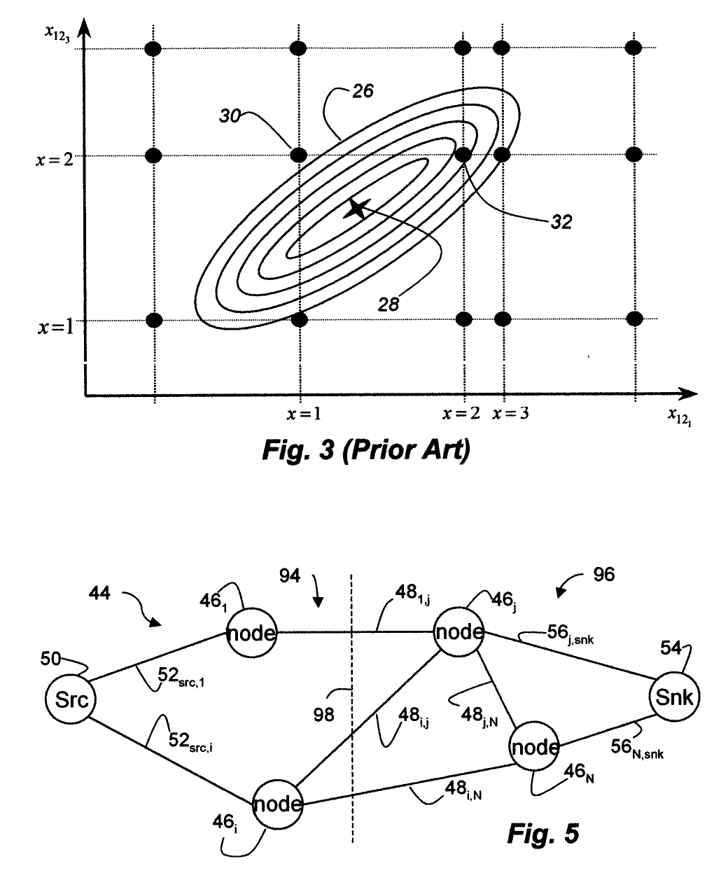

### DETAILED DESCRIPTION OF THE EXEMPLARY PREFERRED EMBODIMENTS

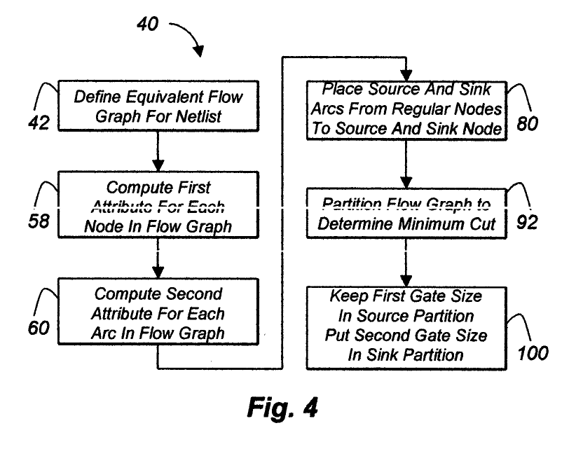

Referring now to FIG. 4, there is shown a flowchart 40 of a novel method to select a set of gate sizes for a netlist wherein for each one of the gates only one of a discrete first gate size and a discrete second gate size is available for selection such that the selection minimizes a sum of weighted delays over all timing edges in the netlist. As will become readily apparent from the following description, the solution to the minimum sum of weighted delays is transformed into a solution of a min-cut/max flow problem. Thus, flowchart 40 relates to the broadest aspects of the inner loop of the reiterative process descsribed above.

To describe the transformation of the solution of the minimum sum of weighted delays in the netlist, which may be any netlist having N number of instances, insts, of gates, it is first assumed that the current size of all gates in the netlist is initially the first size, represented as S=0 and that for each gate only the first size or the second size can be used such that any gate that is resized assumes the second size, represented as S=1. Accordingly, for each j^{th} gate in the netlist its size Sⱼ may be defined as

$${S}_{j} = \{ \begin{matrix}0 \\ 1\end{matrix} \} . \qquad ( 11 )$$

The method of the present invention, practiced in accordance with flowchart 40, will result in a set of gate sizes, \vec{S}, wherein
\vec{S}={S₁,S₂, . . . ,Sⱼ, . . . ,S_{N}}, (12)
which minimizes a sum of weighted delays, as set forth in Eq. (6), which when combined with Eq. (12) may be re-written as:

$${min}_{\vec{S} ∈ {\{ 0 , 1 \}}^{N}} ( {\sum }_{e ∈ E }^{} w ( e ) delay ( e ) ) . \qquad ( 13 )$$

From Eq. (1) and Eq. (7), it follows that the delay, delay(e), on each timing edge as set forth in Eq. (1 3)can be expressed as
ƒ(x_{drv},Cₜₒₜ)=Kx_{drv}+RCₜₒₜ. (14)
As stated above in conjunction with Eq. (1) and Eq. (7), the coefficients K and R are dependent upon the size of the driver gate for the timing edge, and that Cₜₒₜ is the sum of the input capacitance, Cᵢₙ, of each receiver gate on each outgoing edge from the driver gate and a wire capacitance on the net between the driver gate and receiver gates. The input capacitance, Cᵢₙ, is also dependent upon the size of its receiver gate, as stated above. Accordingly, the delay on each edge can be expressed as a function of driver size and the size of the set of receiver gates, such that the delay, delay(e), can be expressed as a function of \vec{S} as
delay(e)=ƒ(S_{drv},\vec{S}ᵣ), (15)
wherein S_{drv} is the size of the driver gate and \vec{S}ᵣ is a vector of sizes of each receiver gate, r, in the set of receiver gates, rec, on the net, n, comprised of each outgoing timing edge from the driver gate, such that r ε rec and n ε nets, wherein nets is the set of all nets in the netlist.

From Eq. (14) and Eq. (15) and the description immediately above, and further given that the set of sizes \vec{S}={0,1} for all of the gates, Eq. (14) may then be rewritten as

$$f ( {S}_{drv} , {C}_{const} + {\sum }_{r ∈ rec}^{} {S}_{r} Δ {C}_{r} ) = K ( {S}_{drv} ) + R ( {S}_{drv} ) {\sum }_{r ∈ rec}^{} {S}_{r} Δ {C}_{r} , \qquad ( 16 )$$

wherein C_{const} is the total capacitance, Cₜₒₜ, on the net for \vec{S}ᵣ=0 and ΔCᵣ is the change of capacitance on the net for Sᵣ=1. The change of capacitance, ΔCᵣ, on the net is expressed as the change of input capacitance of the receiver gate, r, since the wire capacitance on the net is assumed to be constant and therefore does not contribute to the change of capacitance on the net.

It is readily apparent from Eq. (15) and Eq. (16) that for each timing edge there are four cases of delay such that
delay(0,0)=K(0), (17)
delay(1,0)=K(1), (18)

$$\begin{matrix}delay ( 0 , 1 ) = K ( 0 ) + R ( 0 ) {\sum }_{r ∈ rec} Δ {C}_{r} , and & ( 19 ) \\ delay ( 1 , 1 ) = K ( 1 ) + R ( 1 ) {\sum }_{r ∈ rec} Δ {C}_{r} . & ( 20 )\end{matrix}$$

Eq.'s (17)-(20) can be rewritten to obtain expressions for each of the delay coefficients, K(0), K(1), R(0), and R(1) as follows:
K(0)=delay(0,0), (21)
K(1)=delay(1,0), (22)

$$\begin{matrix}R ( 0 ) = \frac{delay ( 0 , 1 ) - delay ( 0 , 0 )}{{\sum }_{r ∈ rec} Δ {C}_{r}} , and & ( 23 ) \\ R ( 1 ) = \frac{delay ( 1 , 1 ) - delay ( 1 , 0 )}{{\sum }_{r ∈ rec} Δ {C}_{r}} . & ( 24 )\end{matrix}$$

Having obtained expressions for the delay coefficients, Eq. (16) can be written as

$$\begin{matrix}delay ( {S}_{drv} , {\vec{S}}_{r} ) = K ( {S}_{drv} ) + R ( {S}_{drv} ) {\sum }_{r ∈ rec} {S}_{r} Δ {C}_{r} , & ( 25 ) \\ = K ( 0 ) + ( K ( 1 ) - K ( 0 ) ) {S}_{drv} + \\ [ R ( 0 ) + ( R ( 1 ) - R ( 0 ) ) {S}_{drv} ] {\sum }_{r ∈ rec} {ΔC}_{r} {S}_{r} . & ( 26 )\end{matrix}$$

or
Eq. (26) can be expanded and the resultant quadratic term S_{drv}Sᵣ algebraically converted knowing S ε (0,1} which infers S²=S, and using the following expressions
(Sᵢ−Sⱼ)²=Sᵢ²+Sⱼ²−2SᵢSⱼ, (27)
|S_{i-S}ⱼ|=Sᵢ+Sⱼ−2SᵢSⱼ, and (28)
SᵢSⱼ=1/2(Sᵢ+Sⱼ−|Sᵢ−Sⱼ|), (29)
such that Eq.26 becomes

$$\begin{matrix}delay ( {S}_{drv} , {\vec{S}}_{r} ) = K ( 0 ) + ( K ( 1 ) - K ( 0 ) ) {S}_{drv} + \\ R ( 0 ) {\sum }_{r ∈ rec} Δ {C}_{r} {S}_{r} - \\ 0.5 {\sum }_{r ∈ rec} ( R ( 0 ) - R ( 1 ) ) Δ {C}_{r} {S}_{drv} - \\ 0.5 {\sum }_{r ∈ rec} ( R ( 0 ) - R ( 1 ) ) Δ {C}_{r} {S}_{r} + \\ 0.5 {\sum }_{r ∈ rec} ( R ( 0 ) - R ( 1 ) ) Δ {C}_{r} \vert {S}_{drv} - {S}_{r} \vert .\end{matrix} \qquad ( 30 )$$

Eq.(26) can now be substituted for the sum of weighted delay expression in Eq.(13) wherein

$$\begin{matrix}{\sum }_{e ∈ E} w ( e ) delay ( e ) = {\sum }_{n ∈ nets} ( {\sum }_{e ∈ n} w ( e ) delay ( {S}_{drv} , {\vec{S}}_{r} ) ) \\ and Eq . ( 30 ) substituted into Eq . ( 31 ) wherein & ( 31 ) \\ {\sum }_{e ∈ E} w ( e ) delay ( e ) = {\sum }_{j ∈ insts} {A}_{j} {S}_{j} + {\sum }_{i , j ∈ insts} {B}_{i , j} \vert {S}_{i} - {S}_{j} \vert + Const & ( 32 )\end{matrix}$$

wherein Aⱼ is a first attribute associated with each j^{th} one of the gates and B_{i,j} is a second attribute associated with each timing edge between each i^{th} one and j^{th} one of the gates.

The derivation of Aⱼ and B_{i,j} in Eq. (32) resulting from the substitution of Eq. (30) into Eq. (31) is within the ordinary skill in the art. In Eq. (30), it is seen that all subexpressions are in the form of αSⱼ and β|Sᵢ−Sⱼ|, wherein α and β are known constant values for a given timing edge e. The expressions for Aⱼ and B_{i,j} in Eq. (32) are obtained by summing the corresponding α and β expressions in Eq. (30). Therefore, it is seen that each of the first and second attributes Aⱼ and B_{i,j} is a function of the above described delay coefficients and weight for each timing edge.

More particularly, it is to be noted that each a that contributes to Aⱼ is associated with either S_{drv} or Sᵣ. Accordingly, each Aⱼ associated with each j^{th} one of the gates has a component when such gate is a driver gate and when such gate is a receiver gate. It may conveniently be represented that for each k^{th} one of the gates its first attribute Aₖ is expressible as a sum of a first increment Aⱼ^{incr} associated with each respective one of the outgoing timing edges from the k^{th} gate when the k^{th} gate is an i^{th} driver gate, and a second increment Aⱼ^{incr} associated with each respective one of the incoming timing edges to the k^{th} gate when the k^{th} gate is a j^{th} receiving gate such that
Aⱼ^{incr}=w(e)(K(1)−K(0))−W(R(0)−R(1))ΔCⱼ/2 (33)
and
Aⱼ^{incr}=W(R(0)+R(1))ΔCⱼ/2. (34)
wherein w(e) is the weight on each one of the timing edges from an i^{th} driver gate to a j^{th} receiver gate, W is the sum of assigned weights w(e) on all outgoing timing edges from the i^{th} driver gate and ΔCⱼ is a difference in input capacitance between the second size and the first size for the j^{th} receiver gate.

From summing the β expressions in Eq. (30), the attribute B_{i,j} may be expressed as
B_{i,j}=W(R(0)−R(1))ΔCⱼ/2. (35)

Eq. (32) is then seen as an expression for the sum of weighted delays in Eq. (13) expressed as a function of gate size when only two sizes for each of the gates are considered. By substituting Eq. (32) into Eq. (13) the expression for the minimum sum of weighted delays becomes

$${min}_{\vec{S} ∈ {\{ 0 , 1 \}}^{N}} ( {\sum }_{j ∈ insts} {A}_{j} {S}_{j} + {\sum }_{i , j ∈ insts} {B}_{i , j} \vert {S}_{i} - {S}_{j} \vert ) . \qquad ( 36 )$$

It is the minimum sum of weighted delays, set forth in Eq. (36), for which the method of the present invention set forth in the description below of the flowchart 40 obtains a solution.

With continued reference to FIG. 4 and additional reference to FIG. 5, the method of flowchart 40 (FIG. 4) includes a step 42 of defining for the netlist an equivalent flow graph 44 (FIG. 5). The flow graph 44 has a plurality of first nodes 46₁, . . . 46ᵢ, 46ⱼ, . . . 46_{N}, a plurality of first arcs 48_{l,i}, . . . 48_{i,j}, . . . 48_{j,N}, a source node 50, a plurality of source first node 46ᵢ corresponds to a respective i^{th} gate instance in the netlist and each first arc 48_{i,j} between an i^{th} node 46ᵢ and a j^{th} node 46ⱼ corresponds to a respective timing edge e between an i^{th} gate instance and a j^{th} gate instance in the netlist.

In the event the i^{th} gate instance has two inputs (or more), such as gate 12₁ (FIG. 1), two (or more) timing edges exist to the j^{th} gate instance, such as gate 12₂, since a timing edge transitions at each respective input of the i^{th} gate instance. It is to be understood that the flow graph 44 contains only one first arc 48_{i,j} between the i^{th} first node 46ᵢ and the j^{th} first node 46ⱼ.

It is known that associated with each of the arcs in a flow graph, such as flow graph 44, a numerical value of a flow capacity is assigned to each arc. The description of the following steps of flowchart 40 describes the computation and assignment of the flow capacity to each arc.

The method of flowchart 40 further includes a step 58 of computing a numerical value of the first attribute Aᵢ for each i^{th} first node 46ᵢ and a step 60 of computing a numerical value of the second attribute B_{i,j} for each first arc 48_{i,j}. In the above derivation of the minimum sum of weighted delays, expressed in Eq. (36), the first attribute Aᵢ was associated with the i^{th} gate instance and the second attribute B_{i,j} was associated with the timing edge between the i^{th} gate instance and the j^{th} gate instance. The first attribute Aᵢ associated with the i^{th} gate instance and second attribute associated with the timing edge between the i^{th} and j^{th} gate instances can now have a numerical value associated with each i^{th} first node 46ᵢ and each first arc 48_{i,j}, respectively, because of the above stated relationships between nodes and arcs in the flow graph 44 and gate instances and timing edges in the netlist.

In the broadest aspects of the present invention, the value of the first attribute Aᵢ is determinable from an assigned weight w(e) and numerical values of a plurality of delay coefficients on each timing edge e outgoing from and incoming to an i^{th} gate instance corresponding to each i^{th} first node 46ᵢ, wherein the value of the delay coefficients is obtained for each case of delay(S_{drv},\vec{S}ᵣ) on each timing edge e. Similarly, the value of the second attribute B_{i,j} for each first arc 48_{i,j} is determinable from the weight w(e) on the corresponding timing edges e from the iₜₕ gate instance corresponding to each i^{th} first node 46ᵢ and the numerical value of selected ones of the delay coefficients on the corresponding timing edge between the i^{th} gate instance and the j^{th} gate instance corresponding to each j^{th} first node 46ⱼ.

As stated immediately above, the value of the delay coefficients is obtained for each case of delay(S_{drv},\vec{S}ᵣ) on each timing edge e in the netlist from an i^{th} gate instance. Since four cases of delay(S_{drv},\vec{S}ᵣ) exist, the delay coefficients may, in one embodiment of the present invention, specifically include a first coefficient, a second coefficient, a third coefficient and a fourth coefficient as set forth immediately below.

The numerical value of the first coefficient is proportional to the delay delay(e) on the timing edge e from the i^{th} gate instance for the case delay(0,0), when the size of the driver gate is the current or first size, S_{drv}=0, and the size of the set of receiver gates is the first size, \vec{S}ᵣ=0. Accordingly, in a preferred embodiment of the present invention, the numerical value of the first coefficient may be computed from the expression of K(0) set forth above in Eq. 21.

The numerical value of the second coefficient is proportional to the delay delay(e) on the timing edge e from the i^{th} gate instance for the case delay(1,0), when the size of the driver gate is the second size, S_{drv}=1, and the size of the set of receiver gates is the first size, \vec{S}r=0. Accordingly, in a preferred embodiment of the present invention, the numerical value of the second coefficient may be computed from the expression of K(1) set forth above in Eq. 22.

The numerical value of the third coefficient is proportional to a difference between the delay delay(e) on the timing edge e from the i^{th} gate instance for the case delay(0,1), when the size of the driver gate is the current or first size, S_{drv}=0, and the size of the set of receiver gates is the second size, \vec{S}_{drv}=1, and the delay delay(e) for the case delay(0,0), when the size of the driver gate is the current or first size, S_{drv}=0, and the size of the set of receiver gates is the first size, \vec{S}ᵣ=0, this difference being divided by the change of input capacitance on the net seen from the i^{th} gate instance between the size of set of receiver gates being the second size and the first size. Accordingly, in a preferred embodiment of the present invention, the numerical value of the third coefficient may be computed from the expression of R(0) set forth above in Eq. (23).

The numerical value of the fourth coefficient is proportional to a difference between the delay delay(e) on the timing edge e from the i^{th} gate instance for the case delay(1,1), when the size of the driver gate is the second size, S_{drv}=1, and the size of the set of receiver gates is the second size, \vec{S}ᵣ=1, and the delay delay(e) for the case delay(1,0), when the size of the driver gate is the second size, S_{drv}=1, and the size of the set of receiver gates is the first size, \vec{S}ᵣ=0, this difference being divided by the change of input capacitance on the net seen from the i^{th} gate instance between the size of set of receiver gates being the second size and the first size. Accordingly, in a preferred embodiment of the present invention, the numerical value of the fourth coefficient may be computed from the expression of R(1) set forth above in Eq. (24).

As described above, the first attribute Aₖ at any k^{th} gate instance includes the summation of each Aᵢ^{incr} set forth in Eq. (33) for each outgoing timing edge from the k^{th} gate instance, being a driver gate, and the summation of each Aᵢ^{incr} set forth in Eq. (34) for each incoming timing edge to the k^{th} gate instance being a receiver gate. Since the k^{th} first node 46ₖ corresponds to the k^{th} gate instance, the numerical value of the first attribute Aₖ associated with the k^{th} first node 46ₖ may be computed from an expression for Aₖ associated with the k^{th} gate instance. Accordingly, in a preferred embodiment of the present invention, a numerical value of the first increment Aₖ for the k^{th} first node 46ₖ may be computed from the expressions for Aᵢ^{incr} and Aⱼ^{incr} set forth above in Eq.'s (33) and (34), respectively, wherein at any k^{th} first node 46ₖ, the total sum of its incremental values Aᵢ^{incr} obtained when such k^{th} first node 46ₖ, was an i^{th} first node 46ᵢ (corresponding to the i^{th} driver gate instance) are summed together with a total sum of its incremental values Aⱼ^{incr} obtained when such k^{th} first node 46ₖ, was a j^{th} first node 46ⱼ (corresponding to the j^{th} receiver gate instance).

Similarly for reasons as described immediately above, a numerical value of the second attribute B_{i,j} for each first arc 48_{i,j} may, in a preferred embodiment of the present invention, be computed from the expression for B_{i,j} set forth in Eq. (35). When the first arc 48_{i,j} corresponds to multiple timing edges between the i^{th} gate instance and j^{th} gate instance, the expression of Eq. (35) is used to obtain an incremental value for each such timing edge and each incremental value summed to obtain the value of the second attribute B_{i,j} for each first arc 48_{i,j}.

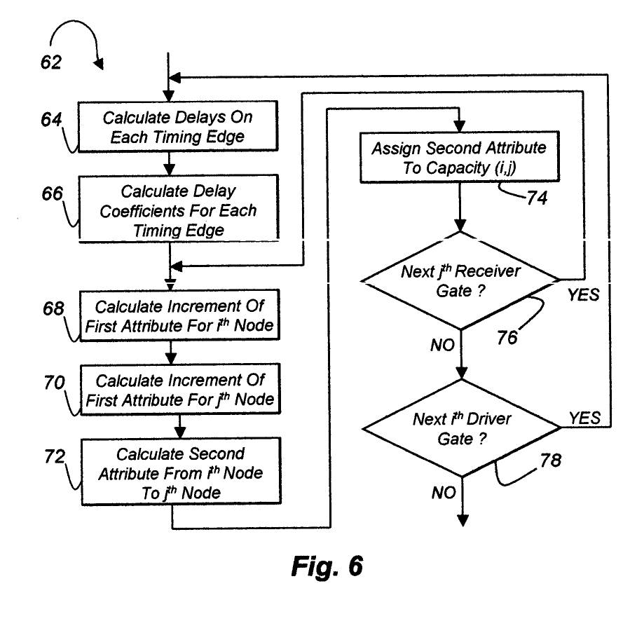

Referring now to FIG. 6, there is shown a flowchart 62 that sets forth a preferred re-iterative method for computing the value of the first attribute Aᵢ at each i^{th} first node 46ᵢ and the value of the second attribute B_{i,j} for each first arc 48_{i,j}, as generally set forth above in the description of steps 58 and 60 of FIG. 4. The method of flowchart 62 is iterated from i=1 to N for each i^{th} first node 46ᵢ and, within each i^{th} iteration, an iteration is performed for each j^{th} first node 46ⱼ on each first arc 48_{i,j} between the i^{th} first node 46ᵢ and each j^{th} first node 46ⱼ.

At each i^{th} iteration the method of flowchart 62 includes a step 64 of calculating a numerical value of the delay delay(e) on each timing edge e transitioning from the corresponding i^{th} gate instance for each case of delay(S_{drv},\vec{S}ᵣ). Each case of the delay is preferably calculated from library timing models for each of the first and second gate sizes of the i^{th} driver gate instance and the set of j^{th} receiver gate instances. The calculation of each case of delay, preferably using the expressions of Eq.'s (17)-(20), results in four numerical delay values: d00=delay(0,0), d01=delay(0,1), d10=delay(1,0) and d11=delay(1,1) associated with each i^{th} iteration.

The method of flowchart 62 further includes, at each i^{th} iteration, a step 66 of calculating a value of each of the first, second, third and fourth delay coefficients for each timing edge e transitioning from the i^{th} gate instance. The values of the first through fourth delay coefficients are preferably calculated using the expressions of Eq.'s (21)-(24), respectively, and the calculated value of delays from step 64 above. As described herein, /ΔCᵣ=ΔCₜₒₜ. Accordingly, the calculation of the first, second, third and fourth delay coefficients results in four delay coefficient values: K0=d00, K1=d10, R0=(d01−d00)/ΔCₜₒₜ and R1=(d11−d10)/ΔCₜₒₜ for each i^{th} iteration, wherein, as described above,

$$Δ {C}_{tot} = {\sum }_{r ∈ rec} Δ {C}_{r} .$$

At each i^{th} iteration, the method of flowchart 62 further includes a step 68 of calculating a value of the first increment Aᵢ^{incr} described above for each i^{th} first node 46ᵢ. The value of Aᵢ^{incr} is preferably computed from the expression of Eq. (33) and from the values of the calculated delay coefficients obtained in the present i^{th} iteration of step 66 above. More particularly, within each i^{th} iteration, the calculated value of the first increment Aᵢ^{incr} computed on the iteration for each j^{th} node results in a value of Aᵢ^{incr}=w(e)(K1−K0)−W(R0−R1)ΔCⱼ/2, and the value of each Aᵢ^{incr} from each iteration for the j^{th} node is accumulated within the present i^{th} iteration to obtain the resultant value of the first attribute Aᵢ for the i^{th} first node 46ᵢ.

Also during the present i^{th} iteration, at each iteration for each j^{th} node the method of flowchart 62 further includes a step 70 of calculating a value of the second increment Aⱼ^{incr} described above for each j^{th} first node 46ⱼ. The value of Aⱼ^{incr} is obtained the expression of Eq. (34) and from the values of the calculated delay coefficients obtained in step 66 above for the present i^{th} iteration. Accordingly, in the present i^{th} iteration, the calculated value of the second increment Aⱼ^{incr} computed at each iteration for the j^{th} first node 46ⱼ results in a value of Aⱼ^{incr}=W(R0+R1)ΔCⱼ/2, and the values of Aⱼ^{incr} computed in the present i^{th} iteration is accumulated with any other value of Aⱼ^{incr} for the j^{th} first node 46ⱼ from any k^{th} iteration of the method of flowchart 62. As stated above, the values of the first increment Aᵢ^{incr} and the second increment Aⱼ^{incr} accumulate at each first node 46 so that a resultant value of the first attribute Aₖ accumulates at any k^{th} first node 46ₖ.

In the present i^{th} iteration, the method of flowchart 62 further includes a step 72 of calculating a value of the second attribute B_{i,j} for each first arc 48_{i,j} outgoing from the current i^{th} first node 46ᵢ. The value of B_{i,j} is obtained from the expression of Eq. (35) and the values of the delay coefficients obtained in step 66 above in the present i^{th} iteration. When the first arc 48_{i,j} corresponds to multiple timing edges between the i^{th} gate instance and j^{th} gate instance, the expression of Eq. (35) is used to obtain an incremental value B_{i,j}^{incr}=W(R0−R1)ΔCⱼ/2 for each such timing edge and each incremental value accumulated to obtain the value of the second attribute B_{i,j} for each first arc 48_{i,j}.

Since in each i^{th} iteration of the method of flowchart 62 the full value of the second attribute B_{i,j} has been accumulated, such method may at this time further include a step 74 of assigning each value of the second attribute B_{i,j} calculated in step 72 in the present i^{th} iteration as a flow capacity capacity(i, j) to each corresponding first arc 48_{i,j} in the flow graph 44. Accordingly, capacity(i, j)=B_{i,j}.

At step 76 a determination is made, whether in the present i^{th} iteration there is another j^{th} first node 46ⱼ. If YES, step 68, step 70, step 72 and step 74 are reiterated for the next j^{th} first node 46ⱼ.

Otherwise, If NO, at step 78 a determination is made whether i<N. If YES, step 64 and all subsequent steps of flowchart 62 are performed as above for the next i^{th}+1 iteration. If NO, the next step of flowchart 40 (FIG. 4) is performed.

Returning to FIG. 4, the next step in the method of the flowchart 40 is the step 80 of placing the source arcs 52_{src,i} and sink arcs 56_{i,snk} in the flow graph 44. Generally, each source arc 52_{src,i} is placed between the source node 50 and each respective i^{th} first node 46ᵢ for which the accumulated value of its first attribute Aᵢ is positive. Similarly, each sink arc 56_{i,snk} is placed between the sink node 54 and each respective i^{th} first node 46ᵢ for the accumulated value of its first attribute A₁ is negative. The flow capacities, capacity(source, i) and capacity(i, sink), are then assigned based on the value of the first attribute of the i^{th} first node 46ᵢ.

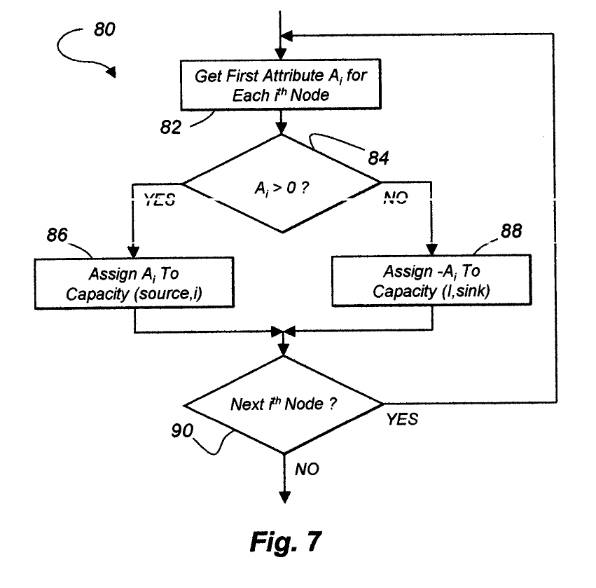

A preferred implementation of the step 80 is shown in FIG. 7. At step 82, the accumulated value Aᵢ is obtained for each i^{th} first node 46ᵢ wherein i=1 to N. At step 84, a decision is made whether Aᵢ>0.

If the decision at step 84 is YES, then at step 86 a source arc 52_{src,i} is placed between the source node 50 and the i^{th} first node 46ᵢ. The source arc 52_{scr,i} is assigned a capacity capacity(source, i)=Aᵢ.

If the decision at step 84 is NO, then at step 88 a sink arc 56_{i,snk} is placed between the i^{th} first node 46ᵢ and the sink node 54. The i^{th} sink are 56_{i,snk} is assigned a capacity capacity(i, sin k)=−Aᵢ.

In either event, the method continues to step 90 whereat a decision is made whether i<N. If YES, an iteration for the next i^{th} node 46ᵢ commences at step 82. If NO, the next step of flowchart 40 is performed.

The method of flowchart 40 further includes a step 92 of partitioning the first nodes 46ₗ, . . . 46ᵢ, 46ⱼ, . . . 46_{N} into a source partition 94 and a sink partition 96, as best seen in FIG. 5. The partitioning is made by a cut, as indicated at 98, such that a sum of the value of the capacity on each of the source arcs 52_{src,1}, . . . 52_{src,i}, sink arcs 56_{j,snk}, . . . 56_{N,snk} and first arcs 48_{l,i}, . . . 48_{i,j}, . . . 48_{j,N} on the cut is a minimum sum for all possible partitions. Those skilled in the art will recognize that Eq. (36) is an equivalent to a min-cut/max flow problem for solvable using a Push-Relabel algorithm for which a solution may be found in N³ or N²E time as in known in the art and specifically taught by Cherkassky, et. al., On Implementing Push-Relabel Algorithm for the Maximum Flow Problem, Algorithmica, vol. 19, pp.'s 390-410, 1997. In a preferred embodiment of the present invention, a Push-Relabel algorithm is used to obtain the cut 98.

The method of flowchart 40 concludes with a step 100 of selecting the current, or first, gate size for each j^{th} gate for which the corresponding j^{th} first node 46ⱼ is in the source partition 94. The step 100 also includes selecting the second size for each j^{th} gate for which the corresponding j^{th} first node 46ⱼ is in the sink partition 96. The set of gate sizes resulting from this step 100 satisfies Eq. (35).

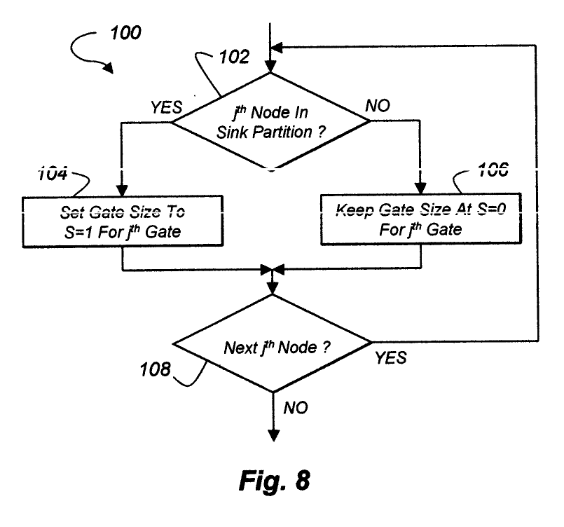

Referring to FIG. 8, there is shown a preferred implementation of the step 100 reiterated for j=1 to N. At step 102, a decision is made whether the current j^{th} first node 46ⱼ is in the sink partition 96.

If the decision at step 102 is YES, then at step 104 the j^{th} instance of the gate corresponding to the j^{th} node 46ⱼ is selected to be the second size. Otherwise, if the decision is NO, then at step 106 the j^{th} instance of the gate corresponding to the j^{th} node 46ⱼ is selected to be the current or first size.

In either event, the method continues to step 108 whereat a decision is made whether j<N. If YES, an iteration for the next j^{th} node 46ⱼ commences at step 102. If NO, the solution to Eq. (36) has been obtained.

From Eq. (36) it can be seen that the forgoing method has obtained the minimum sum of weighted delays for the two gate size problem. Since the cut 98 is made to minimize the sum of flow capacities on the cut arcs, and these flow capacities are assigned the values of B_{i,j} for these arcs computed from the weight and delays on the corresponding timing edges, then it follows that the summation ΣB_{i,j} for the corresponding timing edges, by definition, is minimal. Similarly, the summation ΣAⱼSⱼ is also minimal since only when Aⱼ<0 is there a contribution to this summation. For positive values of Aⱼ the corresponding gate size is Sⱼ=0 and therefore AⱼSⱼ=0.

Of course, a practical netlist uses libraries for gates for which there are more than two sizes. The following description sets forth a method in which the two gate size methods described above are applicable. Generally, a series of iterations using all the available gate sizes may be performed wherein only two of the gate sizes in each iteration are used as above. At the end of each iteration, a resultant set of gate sizes from the those two gate sizes that satisfies Eq. (36) is obtained. In the next iteration, all gate sizes from the prior iteration are resized either up or down, and the two gate size method described above is re-performed. When all possible gate sizes have been considered, or some other exit criteria determined over all such possible iterations, a set of gate sizes that satisfies Eq. (4) may be determined.

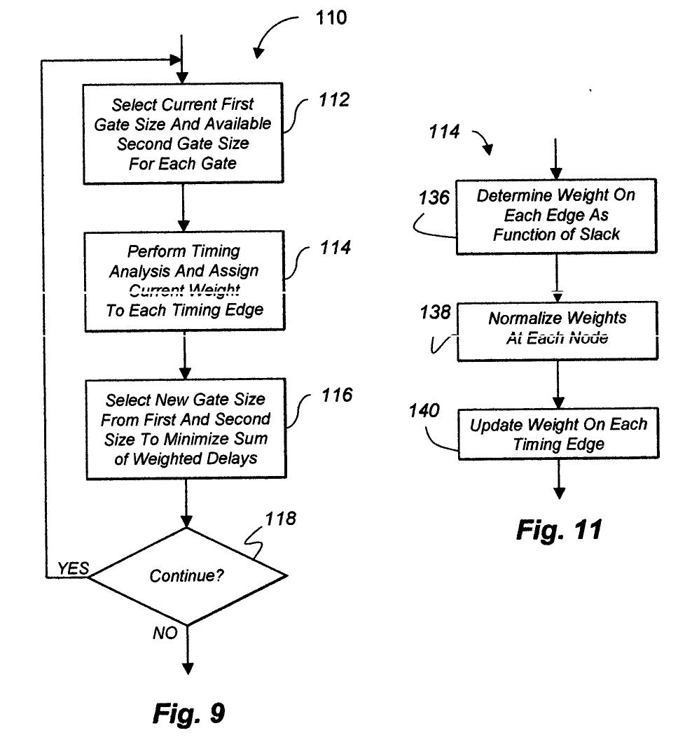

Referring now to FIG. 9, there is shown a flowchart 110 of a reiterative process for a method to select a set \vec{x} of gate sizes for a netlist having N number of gates wherein for each i^{th} one of the gates a predetermined number of discrete gates sizes X₁ is available for selection. The set \vec{x} of gate sizes selected is chosen to minimize worst slack in the netlist. Accordingly, the set \vec{x} of gate sizes may be selected to satisfy the expression of Eq. (4).

In each iteration of the method of flowchart 110 includes a step 112 of selecting a current first gate size X for each instance insts of the gates and an available second gate size for each instance. At an initial iteration of the selecting step 112, the current first gate size X for each instance is selected to be an initially selected one of the available library gate sizes. At each subsequent iteration of the selecting step 112, the current first gate size X for each instance is selected to be a resultant gate size for the same instance from an immediately prior iteration of the flowchart 110, as described below. The availability of the second gate size from the library for each instance is used in a subsequent step described below.

After the current set \vec{x} of gate sizes is selected, the method of flowchart 110 includes a step 114 of performing a timing analysis and assigning a set of weights \vec{w}. Each current weight w(e) in the set of weights \vec{w} is associated with a respective timing edge e in the netlist. The timing analysis determines slack and worst slack in the netlist. As described above, the current weight w(e) is a function of a current worst slack determined for the netlist using the current first gate size.

At step 116, the method of flowchart 110 includes the step of selecting a new gate size X for each instance insts of the gates from the current first gate size and the second gate size identified above such that the set of new gate sizes obtains a minimum sum of weighted delays. When the current first gate size expressed as S=0 and the second gate size expressed as S=1, the step 116 is preferable performed in accordance with the above described method of FIG. 4 wherein the minimum sum of weighted delays is obtained as a solution to a min-cut problem using the two gate sizes. Accordingly, in one embodiment of the present invention the set of new gate sizes resulting from the performance of step 116 satisfies the expression of Eq. (36).

At step 118 a decision is made whether an exit criteria has been reached. If NO, a next iteration of the above described steps of flowchart 110 will be performed. In the next iteration of the flowchart 110, the new gate size of the present iteration selected above becomes the current gate size in the current gate size selecting step 112 of the next iteration.

A YES decision at step 118 indicates that an exit criteria has been determined. Upon exit, the set \vec{x} of gate sizes X is selected from the iteration for which the current worst slack was determined at step 114 to be minimal. The exit criteria can be based upon various factors, such as a total number of iterations, or that each successive iteration indicates that the set of weights begins to converge, as is described in greater detail below, indicating that path delays have been optimized or that worst slack cannot be further improved. A total number of iterations can be based upon a maximum number or some other number relating to the largest maximum number of gate sizes available for any one instance.

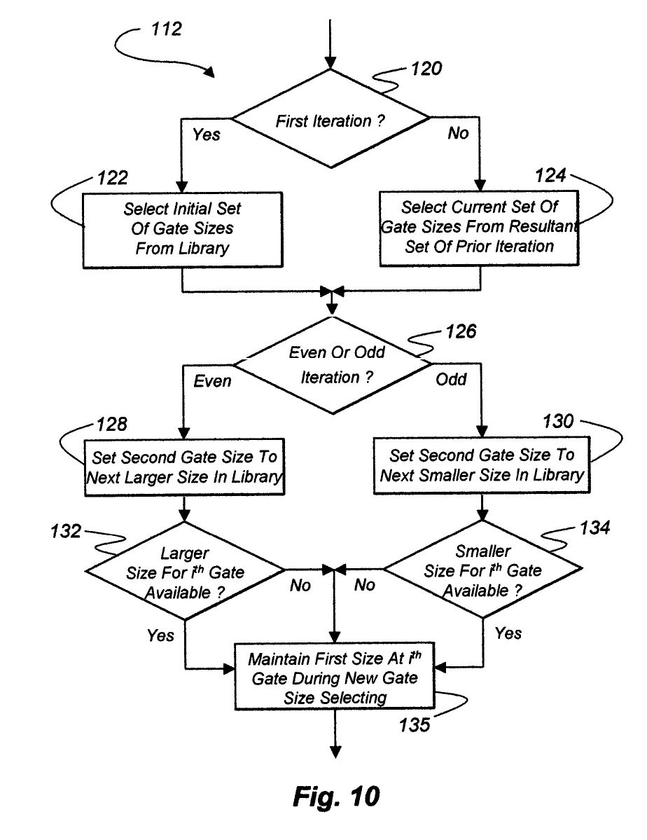

Referring to FIG. 10, there is shown a preferred embodiment of the first and second gate size selecting step 112. At step 120, a decision is made whether the current iteration is an initial iteration. If YES, the initial set \vec{x} of gates sizes X for each instance insts of the gates is selected from the library, as indicated at step 122. If NO, the set \vec{x} of new gates sizes X for each instance insts of the gates from an immediately prior iteration of the new gate size selecting step 116 is selected as the set of current first gate sizes, as indicated at step 124.

In either event, a decision is made at step 126 whether the current iteration is an even number or odd number iteration. If EVEN, then at step 128 the second gate size for the current iteration of the process described in flowchart 110 is set to be the next available larger size from the library. If ODD, then at step 130 the second gate size for the current iteration of the process described in flowchart 110 is set to be the next smaller size from the library.

If the second size is selected to be the next larger size at step 128, an inquiry is made, as indicated at step 132 whether for each i^{th} gate instance such next larger size is available. If YES, then processing continues to the weight assigning step 114 of FIG. (9) described above.

Similarly, if the second size is selected to be the next smaller size at step 130, an inquiry is made, as indicated at step 134 whether for each i^{th} gate instance such next smaller size is available. If YES, then processing continues to the weight assigning step 114 of FIG. (9) described above.

In either event if the decision at step 132 or step 134 is NO, then, as indicated at step 135, for any i^{th} gate instance for which the second size is not available in the library, then for any such i^{th} gate instance the first gate size will be maintained throughout the performance of new gate selecting step 116.

Referring now to FIG. 11, there is shown a preferred embodiment of the timing analysis and weight assigning step 114 of FIG. 9. A static timing analysis to determine slack is well known and need not be further described. As indicated at step 136, the weight w(e) for each associated timing edge e may be determined as a function of slack on each associated timing edge e and worst slack. For example the weight w(e) for each associated timing edge e may be determined in accordance with the expression
w(e)=1/(dw+(slack(e)−WS)) (37)
wherein slack(e) is slack on each associated timing edge e, WS is the worst slack in the netlist and dw is a number greater than zero such that the denominator does not go to zero for the case when the slack on any timing edge is the worst slack for the timing path. Accordingly it is seen that for the most critical edges, their respective weights will be the largest.

As indicated at step 138, the weight w(e) on each associated timing edge e is normalized. Accordingly, at each one of the gates a sum of said weight w(e) on each incoming timing edge e is equal to a sum of said weight w(e) on each outgoing timing edge e.

As indicated at step 140, weight w(e) for each associated timing edge e is updated as a function of a prior weight assigned in an immediately prior iteration at a same one of each associated timing edge e. Updating of weights allows the weights on each edge to converge faster resulting in fewer iterations of the method of FIG. 9. For example, the weights may be updated in accordance with the expression
w(e)=(1−a)wₚᵣₑᵥ(e)+aw_{new}(e) (37)
wherein a is a number between zero and one, wₚᵣₑᵥ(e) is the prior weight, and w_{new}(e) is the current weight prior to the updating step 140.

There has been described above exemplary preferred embodiments for selecting a set of discrete gate size for a netlist. Those skilled in the art may now make numerous uses of, and departures from, the above described embodiments without departing from the inventive principles disclosed herein. Accordingly, the present invention is to be defined solely by the lawfully permitted scope of the appended Claims.

1. In a netlist having a plurality of gates wherein each of the gates has an initial discrete first size and further wherein for each of the gates a discrete second size is available, a method to select a set of gate sizes for the netlist wherein for each one of the gates one of the first size and the second size is selected such that the selection minimizes a sum of weighted delays over all timing edges in the netlist, said method comprising steps of:
defining for the netlist an equivalent flow graph having a plurality of first nodes, a plurality of first arcs, a source node, a plurality of source arcs, a sink node and a plurality of sink arcs, each of said first nodes corresponding to a respective one of the gates and each of the first arcs corresponding to a respective one of the timing edges;
computing a value of a first attribute for each one of said first nodes, said first attribute being determinable from assigned weights and delay coefficients associated with each of the timing edges incoming to and outgoing from one of the gates to which said one of the nodes respectively corresponds, said delay coefficients associated with each of the timing edges being determinable from a plurality of calculated delays between a driver one of the gates and a set of each receiver one of the gates for said driver one of the gates for each combination of said driver one of the gates being one of said first size and said second size and said set of each receiver one of the gates being all of one of said first size and said second size;
computing a value of a second attribute for each one of said first arcs transitioning from one of said first nodes for which said respective one of the gates is said driver one of the gates, said second attribute being determinable from one of said assigned weights and selected ones of said delay coefficients for one of the timing edges for said driver one of the gates for which said one of the nodes respectively corresponds and assigning said value of said second attribute for each one of said first arcs as value of a flow capacity for each same one of said first arcs;
placing each one of said source arcs between said source node and a respective one of said first nodes having a positive value of said first attribute and assigning said positive value as a value of said flow capacity to said one of said source arcs and placing each one of said sink arcs between said sink node and a respective one of said first nodes having a negative value and assigning a negative of said negative value as a value of said flow capacity to said one of said sink arcs;
partitioning said first nodes into a source partition and a sink partition such that a sum of said value of said flow capacity on each of said source arcs, said sink arcs and said first arcs cut by the partitioning is a minimum sum for all possible partitions; and
selecting in said set of gate sizes said first size for each of the gates for which one of said first nodes in said source partition respectively corresponds and said second size for each of the gates for which one of said first nodes in said sink partition respectively corresponds.

2. A method as set forth in claim 1 wherein said partitioning step is performed using a Push-Relabel algorithm.

3. A method as set forth in claim 1 further comprising the step of:
computing a value of said delay coefficients for each one of the timing edges in the netlist wherein said delay coefficients include a first coefficient, a second coefficient, a third coefficient and a fourth coefficient;
said first coefficient being proportional to one of said calculated delays when said driver one of said gates and each receiver one of said gates is said first size;
said second coefficient being proportional to one of said calculated delays when said driver one of said gates is said second size and each receiver one of said gates is said first size;
said third coefficient being proportional to a first difference between one of said calculated delays when said driver one of said gates is said first size and each receiver one of the gates is said second size and one other of said delays when said driver one of said gates is said first size and each receiver one of the gates is said first size divided by a second difference of total input capacitance when each receiver one of the gates is said second size and each receiver one of the gates is said first size; and
said fourth coefficient being proportional to a difference between one of said calculated delays when said driver one of said gates is said second size and each receiver one of the gates is said second size and one other of said delays when said driver one of said gates is said second size and each receiver one of the gates is said first size divided by a second difference of total input capacitance when each receiver one of the gates is said second size and each receiver one of the gates is said first size.

4. A method as set forth in claim 3 wherein said first attribute computing step includes the step of:
computing a first increment of said first attribute for each associated one of the outgoing timing edges at said one of said first nodes when corresponding to one of the gates being said driver one of the gates, said first increment being determinable from all of said delay coefficients on said associated outgoing one of the timing edges;
computing a second increment of said first attribute for each of said one of said first nodes when corresponding to one of said gates being said receiver one of the gates, said second increment being determined from said third delay coefficient and said fourth delay coefficient on each of the timing edges; and
summing each first increment and second increment at each of said one of said first nodes to obtain said value of said first attribute.

5. A method as set forth in claim 3 wherein said second attribute computing step includes the step of:
computing an increment of said second attribute for each of said first arcs as a function of said third coefficient and said fourth coefficient on each corresponding one of the timing edges.

6. A method as set forth in claim 3 further comprising the step of:
calculating each of said calculated delays for each one of the timing edges as a sum of a delay constant through said driver one of the gates and a product of output resistance of said driver one of the gates with a total load capacitance obtained by summing an input capacitance for each driver one of the gates on each of the timing edges transitioning from said driver one of the gates.

7. A method as set forth in claim 3 wherein delay on each of the timing edges is expressible as a function of a size S_{drv} of said driver one of the gates and a size Sᵣ of each receiver one of the gates such that
$$delay ( {S}_{drv} , {\vec{S}}_{rec} ) = K ( {S}_{drv} ) + R ( {S}_{drv} ) {\sum }_{r ∈ rec} {S}_{r} Δ {C}_{r}$$
wherein \vec{S}_{rec} is said size for said set of each receiver one of the gates, K(S_{drv}) is said delay constant through said driver one of the gates, R(S_{drv}) is said output resistance of said driver one of the gates and ΔCᵣ is a difference in input capacitance between said second size and said first size for each receiver one of the gates, such that when said first size is expressed as S=0 and said second size expressed as S=1 said first coefficient is expressed as
$$K ( 0 ) = delay ( 0 , 0 )$$
$$said second coefficient is expressed as$$
$$K ( 1 ) = delay ( 1 , 0 )$$
$$said third coefficient is expressed as$$
$$R ( 0 ) = \frac{delay ( 0 , 1 ) - delay ( 0 , 0 )}{{\sum }_{r ∈ rec} Δ {C}_{r}}$$
$$and said fourth coefficient is expressed as$$
$$R ( 1 ) = \frac{delay ( 1 , 1 ) - delay ( 1 , 0 )}{{\sum }_{r ∈ rec} Δ {C}_{r}} .$$

8. A method as set forth in claim 7 wherein said first attribute for each one of said first nodes is expressible as a sum of a first increment Aₗ^{incr} associated with each 25 respective one of the outgoing timing edges from said driver one of the gates corresponding to said one of said first nodes when being an i^{th} one of said first nodes and a second increment Aⱼ^{incr} associated with on each incoming one of timing edges to each receiving one of the gates corresponding to said one of said first nodes when being a j^{th} one of said first nodes such that
Aᵢ^{incr}=w(e)(K(1)−K(0))−W(R(0)−R(1))ΔCⱼ/2, and
Aⱼ^{incr}=W(R(0)+R(1))ΔCⱼ/2,
wherein w(e) is said assigned weight on each one of the timing edges from said driver one of the gates to one receiving one of the gates, W is the sum of assigned weights w(e) on all outgoing ones of the timing edges from said driver one of the gates and ΔCⱼ is a difference in input capacitance between said second size and said first size for each receiver one of the gates corresponding to said j^{th} one of said first nodes.

9. A method as set forth in claim 7 wherein said second attribute for each one of said first arcs between each i^{th} one and j^{th} one of said fist nodes is expressible as
B_{i,j}=W(R(0)−R(1))ΔCⱼ/2,
wherein w(e) is said assigned weight on each one of the timing edges from said driver one of the gates corresponding to said i^{th} one of said first nodes to one receiving one of the gates corresponding to said j^{th} one of said first nodes, W is the sum of assigned weights w(e) on all outgoing ones of the timing edges from said driver one of the gates and ΔCⱼ is a difference in input capacitance between said second size and said first size for each receiver one of the gates corresponding to said j^{th} one of said first nodes.

10. In a netlist having a plurality of gates wherein for each of the gates a number of discrete gate sizes is available for selection, a reiterative method to select a set of gate sizes for the netlist wherein for each of the gates one of the available sizes is selected such that the selection minimizes worst slack in the netlist, said method comprising the steps of:
selecting a current first gate size and an available second gate size for each one of the gates wherein at an initial iteration of said selecting step said current gate size is selected to be an initially selected one of the available gate sizes and at each subsequent iteration of said selecting step said current gate size is a resultant new gate size for each one of the gates from an immediately prior iteration;
assigning a current weight to each one of the timing edges in the netlist wherein said current weight is a function of a current worst slack determined for the netlist using said current gate size;
selecting said new gate size for each one of the gates from one of said current first gate size and said second gate size wherein such selection of each new gate size minimizes a sum of weighted delays obtained over all timing edges; and
re-iterating said current gate size selecting step, said assigning step and said new gate size selecting step such that at each of the iterations said current worst slack is determined, said set of gate sizes being selected as said current gate size for each of the gates in the iteration for which said current worst slack is determined to be minimal.

11. A method as set forth in claim 10 wherein at each iteration of said current gate size selecting step said second gate size is a next larger one of said available gate sizes on even iterations of said current gate size selecting step and a next smaller one of said available gate sizes on odd iterations of said current gate size selecting step.

12. A method as set forth in claim 11 wherein said current gate size is maintained at any one of the gates in the event said second gate is not available for said any one of the gates in any one iteration of said current gate size selecting step.

13. A method as set forth in claim 11 wherein said assigning step includes the step of performing a static timing analysis to determine slack on each respective one of the timing edges and worst slack.

14. A method as set forth in claim 13 wherein said current weight determining step is performed in accordance with the expression
w(e)=1/(dw+(slack(e)−WS)),
wherein e is a current one of the timing edges, w(e) is said current weight for said current one of the timing edges, slack(e) is slack on said current one of the timing edges, WS is the worst slack in the netlist and dw is a number greater than zero.

15. A method as set forth in claim 11 wherein said assigning step includes the step of normalizing said current weight on each of the timing edges at each one of the gates between the timing edges wherein at each one of the gates a sum of said current weight on each incoming one of the timing edges is equal to a sum of said current weight on each outgoing one of the timing edges.

16. A method as set forth in claim 11 wherein said assigning step includes the step of updating said current weight for each one of the timing edges as a function of a prior weight assigned in an immediately prior iteration at a same one of the timing edges.

17. A method as set forth in claim 16 wherein said updating step is performed in accordance with the expression
w(e)=(1−a)wₚᵣₑᵥ(e)+aw_{new}(e)
wherein e is a current one of the timing edges, w(e) is said current weight for said current one of the timing edges after said updating step, a is a number between zero and one, wₚᵣₑᵥ (e) is said prior weight, w_{new} (e) is said current weight prior to said updating step.

18. A method as set forth in claim 10 wherein said new gate size selecting step includes the steps of:
defining for the netlist an equivalent flow graph having a plurality of first nodes, a plurality of first arcs, a source node, a plurality of source arcs, a sink node and a plurality of sink arcs, each of said first nodes corresponding to a respective one of the gates and each of the first arcs corresponding to a respective one of the timing edges;
computing a value of a first attribute for each one of said first nodes, said first attribute being determinable from assigned weights and delay coefficients associated with each of the timing edges incoming to and outgoing from one of the gates to which said one of the nodes respectively corresponds, said delay coefficients associated with each of the timing edges being determinable from a plurality of calculated delays between a driver one of the gates and a set of each receiver one of the gates for said driver one of the gates for each combination of said driver one of the gates being one of said first size and said second size and said set of each receiver one of the gates being all of one of said first size and said second size;
computing a value of a second attribute for each one of said first arcs transitioning from one of said first nodes for which said respective one of the gates is said driver one of the gates, said second capacity attribute being determinable from one of said assigned weights and selected ones of said delay coefficients for one of the timing edges for said driver one of the gates for which said one of the nodes respectively corresponds and assigning said value of said second attribute for each one of said first arcs as value of a flow capacity for each same one of said first arcs;
placing each one of said source arcs between said source node and a respective one of said first nodes having a positive value of said first attribute and assigning said positive value as a value of said flow capacity to said one of said source arcs and placing each one of said sink arcs between said sink node and a respective one of said first nodes having a negative value and assigning a negative of said negative value as a value of said flow capacity to said one of said sink arcs;
partitioning said first nodes into a source partition and a sink partition such that a sum of said value of said flow capacity on each of said source arcs, said sink arcs and said first arcs cut by the partitioning is a minimum sum for all possible partitions; and
selecting the current size for each of the gates for which one of said first nodes in said source partition respectively corresponds and the next larger available one of the gate sizes for each of the gates for which one of said first nodes in said sink partition respectively corresponds.

19. A method as set forth in claim 18 wherein said partitioning step is performed using a Push-Relabel algorithm.

20. A method as set forth in claim 18 further comprising the step of
computing a value of said delay coefficients for each one of the timing edges in the netlist wherein said delay coefficients include a first coefficient, a second coefficient, a third coefficient and a fourth coefficient;
said first coefficient being proportional to one of said calculated delays when said driver one of said gates and each receiver one of said gates is said current size;
said second coefficient being proportional to one of said calculated delays when said driver one of said gates is said next larger available one of the gate sizes and each receiver one of said gates is said current size;
said third coefficient being proportional to a first difference between one of said calculated delays when said driver one of said gates is said current size and each receiver one of the gates is said next larger available one of the gate sizes and one other of said delays when said driver one of said gates is said current size and each receiver one of the gates is said current size divided by a second difference of total input capacitance when each receiver one of the gates is said next larger available one of the gate sizes and each receiver one of the gates is said current size; and
said fourth coefficient being proportional to a difference between one of said calculated delays when said driver one of said gates is said next larger available one of the gate sizes and each receiver one of the gates is said next larger available one of the gate sizes and one other of said delays when said driver one of said gates is said next larger available one of the gate sizes and each receiver one of the gates is said current size divided by a second difference of total input capacitance when each receiver one of the gates is said next larger available one of the gate sizes and each receiver one of the gates is said current size.

21. A method as set forth in claim 20 wherein said first attribute computing step includes the step of:
computing a first increment of said first attribute for each associated one of the outgoing timing edges at said one of said first nodes when corresponding to one of the gates being said driver one of the gates, said first increment being determinable from all of said delay coefficients on said associated outgoing one of the timing edges;
computing a second increment of said first attribute for each of said one of said first nodes when corresponding to one of said gates being said receiver one of the gates, said second increment being determined from said third delay coefficient and said fourth delay coefficient on each of the timing edges; and
summing each first increment and second increment at each of said one of said first nodes to obtain said value of said first attribute.

22. A method as set forth in claim 20 wherein said second attribute computing step includes the step of:
computing an increment of said second attribute for each of said first arcs as a function of said third coefficient and said fourth coefficient on each corresponding one of the timing edges.

23. A method as set forth in claim 20 further comprising the step of:
calculating each of said calculated delays for each one of the timing edges as a sum of a delay constant through said driver one of the gates and a product of output resistance of said driver one of the gates with a total load capacitance obtained by summing an input capacitance for each driver one of the gates on each of the timing edges transitioning from said driver one of the gates.

24. A method as set forth in claim 20 wherein delay on each of the timing edges is expressible as a function of a size S_{drv} of said driver one of the gates and a size Sᵣ of each receiver one of the gates such that
$$delay ( {S}_{drv} , {\vec{S}}_{rec} ) = K ( {S}_{drv} ) + R ( {S}_{drv} ) {\sum }_{r ∈ rec} {S}_{r} {ΔC}_{r}$$
wherein \vec{S}_{rec} is said size for said set of each receiver one of the gates, K(S_{drv}) is said delay constant through said driver one of the gates, R(S_{drv}) is said output resistance of said driver one of the gates and ΔCr is a difference in input capacitance between said next larger available one of the gate sizes and said current size for each receiver one of the gates, such that when said current size is expressed as S=0 and said next larger available one of the gate sizes expressed as S=1 said first coefficient is expressed as
$$K ( 0 ) = delay ( 0 , 0 )$$
$$said second coefficient is expressed as$$
$$K ( 1 ) = delay ( 1 , 0 )$$
$$said third coefficient is expressed as$$
$$R ( 0 ) = \frac{delay ( 0 , 1 ) - delay ( 0 , 0 )}{{\sum }_{r ∈ rec} Δ {C}_{r}}$$
$$and said fourth coefficient is expressed as$$
$$R ( 1 ) = \frac{delay ( 1 , 1 ) - delay ( 1 , 0 )}{{\sum }_{r ∈ rec} Δ {C}_{r}} .$$

25. A method as set forth in claim 24 wherein said first attribute for each one of said first nodes is expressible as a sum of a first increment Aᵢ^{incr} associated with each respective one of the outgoing timing edges from said driver one of the gates corresponding to said one of said first nodes when being an i^{th} one of said first nodes and a second increment Aⱼ^{incr} associated with on each incoming one of timing edges to each receiving one of the gates corresponding to said one of said first nodes when being a j^{th} one of said first nodes such that
Aᵢ^{incr}=w(e)(K(1)−K(0))−W(R(0)−R(1))ΔCⱼ/2, and
Aⱼ^{incr}=W(R(0)+R(1))ΔCⱼ/2,
wherein w(e) is said assigned weight on each one of the timing edges from said driver one of the gates to one receiving one of the gates, W is the sum of assigned weights w(e) on all outgoing ones of the timing edges from said driver one of the gates and ΔCⱼ is a difference in input capacitance between said second size and said first size for each receiver one of the gates corresponding to said j^{th} one of said first nodes.

26. A method as set forth in claim 24 wherein said second attribute for each one of said first arcs between each i^{th} one and j^{th} one of said fist nodes is expressible as
B_{i,j}=W(R(0)−R(1))ΔC_{j/}2,
wherein w(e) is said assigned weight on each one of the timing edges from said driver one of the gates corresponding to said i^{th} one of said first nodes to one receiving one of the gates corresponding to said j^{th} one of said first nodes, W is the sum of assigned weights w(e) on all outgoing ones of the timing edges from said driver one of the gates and ΔCⱼ is a difference in input capacitance between said second size and said first size for each receiver one of the gates corresponding to said j^{th} one of said first nodes.

27. In a netlist having N number of gates wherein for each i^{th} one of the gates a predetermined number of discrete gates sizes Xᵢ is available for selection, a reiterative method to select a set \vec{x} of gate sizes from all available sizes X for each of the gates that satisfies a first expression
$${min}_{\overline{x} ∈ X} [ {max}_{p ∈ P} ( PathDelay ( p ) - RequiredDelay ( p ) ) ]$$
to minimize a negative value of worst slack WS in the netlist, said method comprising steps of:
selecting a current first gate size X for each instance insts of the gates and an available second size for each instance wherein at an initial iteration of said selecting step said current gate size X is selected to be an initially selected one of the available gate sizes and at each subsequent iteration of said selecting step said current gate size X is a resultant new gate size for each one of the gates from an immediately prior iteration;
assigning a set of weights \vec{w} wherein each weight w(e) in said set of weights \vec{w} is associated with a respective timing edge e in a set of timing edges E in the netlist wherein each weight w(e) is a function of a current worst slack determined for the netlist using said current gate size;
selecting a new gate size X for each instance insts of the gates wherein said new gate size is selected from said first gate size expressed as S=0 and said second gate size expressed as S=1 such that said minimum sum of weighted delays from a set of sizes \vec{S} ε {0,1} containing each new gate size satisfies a third expression
$${min}_{\overline{S} ∈ {\{ 0 , 1 \}}^{N}} ( {\sum }_{j ∈ insts} {A}_{j} {S}_{j} + {\sum }_{i , j ∈ insts} {B}_{i , j} \vert {S}_{i} - {S}_{j} \vert )$$
wherein each Aⱼ and Bⱼ are respectively a first attribute and a second attribute each having a value determinable from said weight w(e) and a plurality of calculated delays delay(e) on each edge e between an i^{th} instance insts of the gates and a j^{th} instance insts of the gates obtained for each case of delay(S_{drv},\vec{S}ᵣ) wherein S_{drv} is a size of a driver one of the gates being one of said current size and said next larger one of the available sizes and \vec{S}ᵣ is a size of receiving ones of the gates associated with said driver one of the gates all being one of said current size and said next larger one of the available sizes; and
re-iterating said current gate size selecting step, said assigning step and said new gate size selecting step such that at each of the iterations said current worst slack is determined, said set \vec{x} of gate sizes X being selected as said current gate size for each of the gates in the iteration for which said current worst slack is determined to be minimal.

28. A method as set forth in claim 27 wherein at each iteration of said current gate size selecting step said second gate size is a next larger one of said available gate sizes on even iterations of said current gate size selecting step and said second gate size is a next smaller one of said available gate sizes on odd iterations of said current gate size selecting step.

29. A method as set forth in claim 28 wherein said current gate size is maintained at any one of the gates in the event said second gate size is not available for said any one of the gates in any one of the iterations of said current gate size selecting step.

30. A method as set forth in claim 28 wherein said assigning step includes the step of performing a static timing analysis to determine slack on each associated timing edge e and worst slack.

31. A method as set forth in claim 30 wherein said weight determining step is performed in accordance with the expression
w(e)=1/(dw+(slack(e)−WS)),
wherein slack(e) is slack on each associated timing edge e, WS is the worst slack in the netlist and dw is a number greater than zero.

32. A method as set forth in claim 28 wherein said assigning step includes the step of normalizing said weight w(e) on each associated timing edge e at each one of the gates wherein at each one of the gates a sum of said weight w(e) on each incoming timing edge e is equal to a sum of said weight w(e) on each outgoing timing edge e.

33. A method as set forth in claim 28 wherein said assigning step includes the step of updating said weight w(e) for each associated timing edge e as a function of a prior weight assigned in an immediately prior iteration at a same one of each associated timing edge e.

34. A method as set forth in claim 33 wherein said updating step is performed in accordance with the expression
w(e)=(1−a)wₚᵣₑᵥ(e)+aw_{new}(e)
wherein a is a number between zero and one, wₚᵣₑᵥ(e) is said prior weight, w_{new}(e) is said current weight prior to said updating step.

35. A method as set forth in claim 27 wherein said new gate size selecting step includes the steps of:
defining for the netlist an equivalent flow graph having N number of first nodes, a plurality of first arcs, a source node, a plurality of source arcs, a sink node and a plurality of sink arcs, each i^{th} one of said first nodes corresponding to a respective i^{th} one of the gates and each of said first arcs between an i^{th} one and a j^{th} one of said first nodes corresponding to a respective one of each timing edge e between an i^{th} one and a j^{th} one of the gates;
computing said value Aᵢ of said first attribute for each i^{th} one of said first nodes, said first attribute being determinable from said weight w(e) and a plurality of delay coefficients for each associated timing edge e incoming to and outgoing from a corresponding i^{th} one of the gates to which said one of the nodes respectively corresponds wherein said delay coefficients have a value for each associated timing edge e determinable from said calculated delays delay(e) on each edge e obtained for each case of delay(S_{drv},\vec{S}ᵣ);
computing said value B_{i,j} of said second attribute for each one of said first arcs transitioning from said i^{th} one of said first nodes to a j^{th} one of said first nodes for which said corresponding i^{th} one of the gates is said driver one of the gates and said a corresponding j^{th} one the gates is one receiver one of the gates, said second attribute being determinable from said weight on each timing edge e from said i^{th} one of the gates and selected ones of said delay coefficients on each corresponding timing edge between said i^{th} one of the gates and said j^{th} one the gates and assigning said value B_{i,j} of said second attribute for each one of said first arcs as value of a flow capacity for each same one of said first arcs;
placing each one of said source arcs between said source node and each respective i^{th} one of said first nodes for which Aᵢ>0 and assigning Aᵢ as a value of said flow capacity to said one of said source arcs and placing each one of said sink arcs between said sink node and each respective one i^{th} of said first nodes for which Aᵢ<0 and assigning —Aᵢ as a value of said flow capacity to said one of said sink arcs;
partitioning said first nodes into a source partition and a sink partition such that a sum of said value of said flow capacity on each of said source arcs, said sink arcs and said first arcs cut by the partitioning is a minimum sum for all possible partitions; and
selecting said first gate size for each of the gates for which one of said first nodes in said source partition respectively corresponds and said second gate size for each of the gates for which one of said first nodes in said sink partition respectively corresponds.

36. A method as set forth in claim 35 wherein said partitioning step is performed using a Push-Relabel algorithm.

37. A method as set forth in claim 35 further comprising the step of:
computing a value of said delay coefficients for each one of the timing edges in the netlist wherein said delay coefficients include a first coefficient, a second coefficient, a third coefficient and a fourth coefficient;
said first coefficient being proportional to one of said calculated delays when said driver one of said gates and each receiver one of said gates is said current size;
said second coefficient being proportional to one of said calculated delays when said driver one of said gates is said next larger available one of the gate sizes and each receiver one of said gates is said current size;
said third coefficient being proportional to a first difference between one of said calculated delays when said driver one of said gates is said current size and each receiver one of the gates is said next larger available one of the gate sizes and one other of said delays when said driver one of said gates is said current size and each receiver one of the gates is said current size divided by a second difference of total input capacitance when each receiver one of the gates is said next larger available one of the gate sizes and each receiver one of the gates is said current size; and
said fourth coefficient being proportional to a difference between one of said calculated delays when said driver one of said gates is said next larger available one of the gate sizes and each receiver one of the gates is said next larger available one of the gate sizes and one other of said delays when said driver one of said gates is said next larger available one of the gate sizes and each receiver one of the gates is said current size divided by a second difference of total input capacitance when each receiver one of the gates is said next larger available one of the gate sizes and each receiver one of the gates is said current size.

38. A method as set forth in claim 37 wherein said first attribute computing step includes the step of:
computing a first increment of said first attribute for each associated one of the outgoing timing edges at said one of said first nodes when corresponding to one of the gates being said driver one of the gates, said first increment being determinable from all of said delay coefficients on said associated outgoing one of the timing edges;
computing a second increment of said first attribute for each of said one of said first nodes when corresponding to one of said gates being said receiver one of the gates, said second increment being determined from said third delay coefficient and said fourth delay coefficient on each of the timing edges; and
summing each first increment and second increment at each of said one of said first nodes to obtain said value of said first attribute.

39. A method as set forth in claim 37 wherein said second attribute computing step includes the step of:
computing an increment of said second attribute on each of the timing edges wherein said selected ones of said delay coefficients are said third coefficient and said fourth coefficient.

40. A method as set forth in claim 37 further comprising the step of:
calculating said calculated delays for each one of the timing edges as a sum of a delay constant through said driver one of the gates and a product of output resistance of said driver one of the gates with a total load capacitance obtained by summing an input capacitance for each driver one of the gates on each of the timing edges transitioning from said driver one of the gates.

41. A method as set forth in claim 37 wherein
$$delay ( {S}_{drv} , {\vec{S}}_{rec} ) = K ( {S}_{drv} ) + R ( {S}_{drv} ) {\sum }_{r ∈ rec} {S}_{r} Δ {C}_{r}$$
and further wherein K(S_{drv}) is a delay constant through said driver one of the gates, R(S_{drv}) is an output resistance of said driver one of the gates and ΔCᵣ is a difference in input capacitance between said next larger available one of the gate sizes and said current size for each receiver one of the gates, such that when said current size is expressed as S=0 and said next larger available one of the gate sizes expressed as S=1 said first coefficient is expressed as
$$K ( 0 ) = delay ( 0 , 0 )$$
$$said second coefficient is expressed as$$
$$K ( 1 ) = delay ( 1 , 0 )$$
$$said third coefficient is expressed as$$
$$R ( 0 ) = \frac{delay ( 0 , 1 ) - delay ( 0 , 0 )}{{\sum }_{r ∈ rec} Δ {C}_{r}}$$
$$and said fourth coefficient is expressed as$$
$$R ( 1 ) = \frac{delay ( 1 , 1 ) - delay ( 1 , 0 )}{{\sum }_{r ∈ rec} Δ {C}_{r}} .$$

42. A method as set forth in claim 41 wherein said first attribute for each one of said first nodes is expressible as a sum of a first increment Aᵢ^{incr} associated with each respective one of the outgoing timing edges from said driver one of the gates corresponding to said one of said first nodes when being an i^{th} one of said first nodes and a second increment Aⱼ^{incr} associated with on each incoming one of timing edges to each receiving one of the gates corresponding to said one of said first nodes when being a j^{th} one of said first nodes such that
Aᵢ^{incr}=w(e)(K(1)−K(0))−W(R(0)−R(1))ΔCⱼ/2, and
Aⱼ^{incr}=W(R(0)+R(1))ΔCⱼ/2,
wherein w(e) is said assigned weight on each one of the timing edges from said driver one of the gates to one receiving one of the gates, W is the sum of assigned weights w(e) on all outgoing ones of the timing edges from said driver one of the gates and ΔCⱼ is a difference in input capacitance between said second size and said first size for each receiver one of the gates corresponding to said j^{th} one of said first nodes.

43. A method as set forth in claim 41 wherein said second attribute for each one of said first arcs between each i^{th} one and j^{th} one of said fist nodes is expressible as
B_{i,j}=W(R(0)−R(1))ΔCⱼ/2,
wherein w(e) is said assigned weight on each one of the timing edges from said driver one of the gates corresponding to said i^{th} one of said first nodes to one receiving one of the gates corresponding to said j^{th} one of said first nodes, W is the sum of assigned weights w(e) on all outgoing ones of the timing edges from said driver one of the gates and ΔCⱼ is a difference in input capacitance between said second size and said first size for each receiver one of the gates corresponding to said j^{th} one of said first nodes.

44. In a netlist having N number of instances insts of gates wherein each of the gates has an initial discrete first size expressed as S=0 and further wherein for each of the gates a discrete second size expressed as S=1 is available, a method to select a set of gates sizes \sqrt{S} ε {0,1} for the netlist wherein for each one of the gates one of the first size and the second size is selected such that the selection minimizes a sum of weighted delays expressed as
$${min}_{\overline{S} ∈ {\{ 0 , 1 \}}^{N}} ( {\sum }_{j ∈ insts} {A}_{j} {S}_{j} + {\sum }_{i , j ∈ insts} {B}_{i , j} \vert {S}_{i} - {S}_{j} \vert )$$
over all timing edges between an i^{th} one and a j^{th} one of the gates in the netlist, said method comprising steps of:
defining for the netlist an equivalent flow graph having N number of first nodes, a plurality of first arcs, a source node, a plurality of source arcs, a sink node and a plurality of sink arcs, each i^{th} one of said first nodes corresponding to a respective i^{th} one of the gates and each of said first arcs between an i^{th} one and a j^{th} one of said first nodes corresponding to a respective one of each timing edge e between an i^{th} one and a j^{th} one of the gates;
computing a value of a first attribute Aᵢ for each i^{th} one of said first nodes, said first attribute being determinable from an assigned weight w(e), a plurality of delay coefficients on each edge e incoming to and outgoing from an i^{th} instance insts of the gates obtained for each case of delay(S_{drv},\vec{S}ᵣ) wherein S_{drv} is a size of a driver one of the gates being one of said current size and said next larger one of the available sizes and \vec{S}ᵣ is a size of receiving ones of the gates associated with said driver one of the gates all being one of said current size and said next larger one of the available sizes;
computing a value of said second attribute B_{i,j} for each one of said first arcs transitioning from said i^{th} one of said first nodes to a j^{th} one of said first nodes for which said corresponding i^{th} one of the gates is said driver one of the gates and said a corresponding j^{th} one the gates is one receiver one of the gates, said second attribute being determinable from said weight w(e) on each timing edge e from said i^{th} one of the gates and selected ones of said delay coefficients on each corresponding timing edge between said i^{th} one of the gates and said j^{th} one the gates and a assigning said value of B_{i,j} to a flow capacity for each same one of said first arcs;
placing each one of said source arcs between said source node and each respective i^{th} one of said first nodes for which Aᵢ>0 and assigning Aᵢ as a value of said flow capacity to said one of said source arcs and placing each one of said sink arcs between said sink node and each respective one i^{th} of said first nodes for which Aᵢ<0 and assigning —Aᵢ as a value of said flow capacity to said one of said sink arcs;
partitioning said first nodes into a source partition and a sink partition such that a sum of said value of said flow capacity on each of said source arcs, said sink arcs and said first arcs cut by the partitioning is a minimum sum for all possible partitions; and
selecting said current gate size for each of the gates for which one of said first nodes in said source partition respectively corresponds and said next larger available one of the gate sizes for each of the gates for which one of said first nodes in said sink partition respectively corresponds.

45. A method as set forth in claim 44 wherein said partitioning step is performed using a Push-Relabel algorithm.

46. A method as set forth in claim 44 further comprising the step of:
computing for each one of the timing edges in the netlist a value of said delay coefficients wherein said delay coefficients include a first coefficient, a second coefficient, a third coefficient and a fourth coefficient;
said first coefficient being proportional to one of said calculated delays when said driver one of said gates and each receiver one of said gates is said first size;
said second coefficient being proportional to one of said calculated delays when said driver one of said gates is said second size and each receiver one of said gates is said first size;
said third coefficient being proportional to a first difference between one of said calculated delays when said driver one of said gates is said first size and each receiver one of the gates is said second size and one other of said delays when said driver one of said gates is said first size and each receiver one of the gates is said first size divided by a second difference of total input capacitance when each receiver one of the gates is said second size and each receiver one of the gates is said first size; and
said fourth coefficient being proportional to a difference between one of said calculated delays when said driver one of said gates is said second size and each receiver one of the gates is said second size and one other of said delays when said driver one of said gates is said second size and each receiver one of the gates is said first size divided by a second difference of total input capacitance when each receiver one of the gates is said second size and each receiver one of the gates is said first size.

47. A method as set forth in claim 46 wherein said first attribute computing step includes the step of:
computing a first increment of said first attribute as a function of all of said delay coefficients for each of said one of said first nodes on each of the timing edges for said corresponding one of said gates being said driver one of the gates;
computing a second incremental of said first attribute as a function of said third delay coefficient and said fourth delay coefficient for each of said one of said first nodes on each of the timing edges for said corresponding one of said gates being said receiver one of the gates; and
summing each first increment and second increment for each of said one of said first nodes to obtain said first attribute.

48. A method as set forth in claim 46 wherein said second attribute computing step includes the step of:
computing an increment of said second attribute on each of the timing edges wherein said selected ones of said delay coefficients are said third coefficient and said fourth coefficient.

49. A method as set forth in claim 46 further comprising the step of:
calculating said calculated delays for each one of the timing edges as a sum of a delay constant through said driver one of the gates and a product of output resistance of said driver one of the gates with a total load capacitance obtained by summing an input capacitance for each driver one of the gates on each of the timing edges transitioning from said driver one of the gates.

50. A method as set forth in claim 46 wherein delay on each of the timing edges is expressible as a function of a size S_{drv} of said driver one of the gates and a size Sᵣ of each receiver one of the gates such that
$$delay ( {S}_{drv} , {\vec{S}}_{rec} ) = K ( {S}_{drv} ) + R ( {S}_{drv} ) {\sum }_{r ∈ rec} {S}_{r} Δ {C}_{r}$$
wherein \vec{S}_{rec} is said size for said set of each receiver one of the gates, K(S_{drv}) is said delay constant through said driver one of the gates, R(S_{drv}) is said output resistance of said driver one of the gates and ΔCᵣ is a difference in input capacitance between each receiver one of the gates being said second size and said first size, such that when said first size is expressed as S=0 and said second size expressed as S=1 said first coefficient is expressed as
$$K ( 0 ) = delay ( 0 , 0 )$$
$$said second coefficient is expressed as$$
$$K ( 1 ) = delay ( 1 , 0 )$$
$$said third coefficient is expressed as$$
$$R ( 0 ) = \frac{delay ( 0 , 1 ) - delay ( 0 , 0 )}{{\sum }_{r ∈ rec} Δ {C}_{r}}$$
$$and said fourth coefficient is expressed as$$
$$R ( 1 ) = \frac{delay ( 1 , 1 ) - delay ( 1 , 0 )}{{\sum }_{r ∈ rec} Δ {C}_{r}} .$$

51. A method as set forth in claim 50 wherein said first attribute for each one of said first nodes is expressible as a sum of a first increment Aᵢ^{incr} associated with each respective one of the outgoing timing edges from said driver one of the gates corresponding to said one of said first nodes when being an i^{th} one of said first nodes and a second increment Aⱼ^{incr} associated with on each incoming one of timing edges to each receiving one of the gates corresponding to said one of said first nodes when being a j^{th} one of said first nodes such that
Aᵢ^{incr}=w(e)(K(1)−K(0))−W(R(0)−R(1))ΔCⱼ/2, and
Aⱼ^{incr}=W(R(0)+R(1))ΔCⱼ/2,
wherein w(e) is said assigned weight on each one of the timing edges from said driver one of the gates to one receiving one of the gates, W is the sum of assigned weights w(e) on all outgoing ones of the timing edges from said driver one of the gates and ΔCⱼ is a difference in input capacitance between said second size and said first size for each receiver one of the gates corresponding to said j^{th} one of said first nodes.

52. A method as set forth in claim 50 wherein said second attribute for each one of said first arcs between each i^{th} one and j^{th} one of said fist nodes is expressible as
B_{i,j}=W(R(0)−R(1))ΔCⱼ/2,
wherein w(e) is said assigned weight on each one of the timing edges from said driver one of the gates corresponding to said i^{th} one of said first nodes to one receiving one of the gates corresponding to said j^{th} one of said first nodes, W is the sum of assigned weights w(e) on all outgoing ones of the timing edges from said driver one of the gates and ΔCⱼ is a difference in input capacitance between said second size and said first size for each receiver one of the gates corresponding to said j^{th} one of said first nodes.
